(19) United States
(12) Patent Application Publication
(10) Pub. No.: US 2011/0307347 A1
(43) Pub. Date: Dec. 15, 2011

(54) Bid Evaluation Device and Communication Network System and Method

(76) Inventor: Ryan Jentsch, Kyle, TX (US)

(21) Appl. No.: 12/814,548

(22) Filed: Jun. 14, 2010

(51) Int. Cl. G06Q 30/00

(52) U.S. Cl. 705/26.4

(57) ABSTRACT

A bid evaluation system delivers an evaluation report of an estimated bid of a project. One or more client evaluation device can access a bid evaluation server over a communications network. The bid evaluation server controls a database of metadata representing new projects, such as construction, supply or other projects open for bids in response to requests for bid, and historical projects of similar type and project details. A client evaluation device, authorized for access to the system, communicates over the network to the bid evaluation server an identifier recognizable to the bid evaluation server corresponding to a new project. The bid evaluation server searches the database for contents corresponding to project items of historical projects related to project items of the new project. The bid evaluation server calculates an estimated bid of each project item of the new project and a total estimate bid of the new project. The bid evaluation server reports the estimated bid of each project item and the total estimate bid of the new project over the network to the client evaluation device. The client evaluation device can also communicate to the bid evaluation server a historical identifier corresponding to one or more historical projects. The bid evaluation server searches and variously calculates and/or reports historical bids of the project items.

### TECHNICAL FIELD

The present disclosure relates generally to communication devices and networks for evaluating bids, and, more particularly, relates to networked communication devices for review, evaluation and appraisement of project bids in a competitively bid enterprise, for example, a competitive bidding schema of a state or federal government construction project goods and services procurer.

### BACKGROUND

Contractors must often make bids in response to requests for proposal in order to secure award of projects. Requests for proposal are often published by companies, governmental agencies, or similar groups, and the groups use bidding processes to select bids and contractors to perform projects or supply materials, equipment, or the like. In government service and supply contracting, for example, a governmental entity, such as a federal, state, or local city or township government or agency, must obtain competitive bids from contractors through established procedures. The contract bidders respond to a request for proposal of the governmental entity, by submitting a proposed bid. From the proposed bids received, the governmental entity selects a contractor to perform the project.

Certain aids, such as estimation software, have been employed by contractors to assist them in formulating bids. The aids require the user to provide costs, such as labor, materials, and supplies costs, and expected profit data. Such aids basically sum costs, perform estimation of quantity or amount based on the contractor's input specifications, and generate related pricing for the bid calculated from the contractor's input. To use the aids, the user must typically already have available its costs and relevant data for the calculation. Such aids are, therefore, of limited value in equipping the bidder with extraneous information that may be relevant to the bid but not already known to the bidder. In the case of estimation software, such software is typically an application software which is stored and processed by a computer of the user and requires the user to input relevant data used by the application.

Certain online auction and bidding schemes are employed, such as in sales of personal items (e.g., EBay™) and contracting (e.g., Elance™). These auction schemes allow purchasers to make offers for items or contractors to bid for providing services. The poster of the item or the services request can accept a bidder's offer, such as the highest bid for purchase of the item or lowest or preferred bid for providing the service. The current bid subject to acceptance at each instance, such as highest or lowest, may be made known to those wishing to bid. However, historical information of prices paid for similar items or services in the past is not generally available to the current bidders. In any event, the conventional auction and bidding schemes differ from any competitive bidding process as would be typical for many contractor situations, particularly those in construction and similar industry for state or federal government projects.

It would, therefore, be desirable to provide new and improved systems and methods for evaluation and appraisement of competitively bid projects, particularly, but not limited to, construction project bids. It would also be desirable to provide easy access to information relevant to such competitive bid projects, including historical prices bid for projects, via network communications of specialized devices for bidding evaluation.

### SUMMARY

An embodiment of the invention is a system for bid evaluation of a project, the project includes project items, one or more prior bid of the project may be pending, one or more historical bid of one or more historical project was previously pending, and the one or more historical project includes at least some of the project items. The system is accessible over a data communications network by an evaluation terminal. The system includes a first table containing data representing the project and the one or more prior bid, if any, a second table containing data representing the one or more historical project and the one or more historical bid of the historical project, a first index relating data of the first table of the project to data of the first table of the one or more prior bid of the project, and a second index relating data of the second table of each historical project to data of the second table of one of the historical project of the one or more historical project. The system also includes a controller communicatively connected to the data communications network and the first table, the second table, the first index and the second index, a memory connected to the controller, a script unit connected to the data communications network and the controller, the script unit responsive to communications of the evaluation terminal on the data communications network, the script unit processes received communications of the evaluation terminal, a search instruction written by the script unit on processing received communications of the evaluation terminal over the data communications network and stored in the memory, a project bid unit connected to the controller and responsive to the script unit, the project bid unit processes the search instruction to search the first table per the first index and retrieve to the memory the data of the first table representing the project, together with the project items of the project, and the one or more prior bid, if any, of the project, and to search the second table per the second index and retrieve to the memory the data of the second table representing at least certain of the one or more historical bid, together with the project items, respectively, of the historical bid, an estimated bid of the project and of each of the project items of the project stored in the memory, the project bid unit processes the data of the second table representing the at least certain of the one or more historical bid to obtain the estimated bid for each of the project items of the project, an evaluation reporter connected to the controller and responsive to the project bid unit, and an evaluation report, the evaluation reporter processes and stores in the memory each of the project items of the project and the estimated bid of the project item, respectively, associated to the project item, tabularizes the evaluation report presenting the project items of the project and the estimated bid of each project item of the project, and communicates the evaluation report over the data communications network destined to the evaluation terminal.

In other embodiments of the system, a conversion unit is connected to the controller and the project bid unit. The conversion unit processes the data of the at least certain of the one or more historical bid and the data representing the one or more prior bids, to comport to the data representing the project items of the project.

In yet other embodiments of the system, the search instruction relates to one or more historical project but not the project and the system includes a historical bid unit connected to the controller and responsive to the project bid unit, the project bid unit processes the search instruction to search the second table per the second index and retrieve to the memory the data of the second table representing the one or more historical bid, together with the project items, respectively, of the historical project of each one or more historical bid, and an evaluated bid of each of the one or more historical project and the project items, respectively, of each historical project. The project bid unit processes the data of the second table representing the one or more historical bid to obtain the evaluated bid for each project item of each of the one or more the historical project, averaged for each project item of the one or more historical project. The evaluation reporter constructs the evaluation report tabularly presenting each project item of the one or more historical project corresponding to the evaluated bid of the project item.

In further embodiments of the system, a computer readable database includes the first table, the second table, the first index, and the second index, and a server device communicatively connected to the data communications network and to the computer readable database, the server device includes the controller, the memory, the script unit, the search instruction, the project bid unit, the estimated bid, the evaluation reporter, and the evaluation report.

Another embodiment of the invention is a method of evaluating bidding of a project. The method includes providing a server device communicatively connected to a data communications network, the server device includes memory and a bid unit and an evaluation report server connected to the memory, providing a relational database connected to the server device containing data representing the project, data representing any prior bids of the project, and data representing historical bids of historical projects, the project and the historical projects each include respective project items, receiving by the server device a tracker device identifying the project to the server device, from an authorized client device over the data communications network, processing the tracker device by the bid unit of the server device to obtain a project identification of the project, writing a search request stored in the memory by the bid unit for the project identification, searching the database by the bid unit per the search request, for the data representing the project, the data representing any prior bids of the project, and the data representing historical bids of historical projects related to the project, retrieving by the bid unit to the memory the data representing the project, the data representing any prior bids of the project, and any of the data representing historical bids of historical projects related to the project, sorting by the bid unit in the memory the data representing historical bids from the step of retrieving, for each project item related to the project of the historical projects, calculating by the bid unit an average evaluated bid of each project item of the project based on the historical bids of the project item of the historical projects, saving in the memory by the bid unit the average evaluated bid of each project item, relating in the memory by the bid unit the average evaluated bid of each project item to the respective project item of the project, calculating by the bid unit a cumulative evaluated bid of the project as a sum of the average evaluated bid of each project item of the project, creating an evaluation report table of the project items of the project by the evaluation report server, the average evaluated bid of each project item, and the cumulative evaluated bid of the project, and sending the evaluation report table by the server device, over the data communications network to the authorized client device.

In other embodiments, the method includes providing a website of the server device accessible by the authorized client device via the data communications network, providing a client device account database connected to the server device, the client device account database contains a user account for the authorized client device, searching the client device account database for the user account after the step of receiving the tracker device and before the step of processing the tracker device, analyzing the user account by the server device to confirm the authorized client device is permitted to continue the step of processing the tracker device, and delivering by the server device a registration page of the website over the data communications network to the authorized client device, if the step of analyzing fails to confirm the authorized client device is permitted. The tracker device includes a log-in key of the authorized client device recognizable to the server device.

Yet another embodiment of the invention is a a method of evaluating bidding of a project. The method includes receiving by the server device a historical tracker device identifying one or more historical item represented by the data of historical projects of the relational database, from an authorized client device over the data communications network, processing the historical tracker device by the bid unit of the server device to obtain an item identification of each of the one or more historical item, the item identification is related to one or more project items of the one or more historical projects, writing a historical search request stored in the memory by the bid unit for the item identification, searching the database by the bid unit per the historical search request, for any data representing the one or more project items of the one or more historical projects, saving by the bid unit to the memory the data representing the one or more project items, sorting by the bid unit in the memory the data representing the one or more project items, to associate the respective data representing each project item, respectively, of the historical bids, calculating by the bid unit an average historical bid of each project item of the step of saving, based on the historical bids of the project item of the historical projects of the step of sorting by the bid unit in the memory the data representing one or more project items, storing in the memory by the bid unit the average historical bid of each project item, relating in the memory by the bid unit the average historical bid of each project item to the respective project item of the historical projects, creating an historical evaluation report table of the project items and the average historical bid of each project item of the historical projects, and sending the historical evaluation report table by the server device, over the data communications network to the authorized client device.

In a further embodiment, the method includes receiving by the server device a tracker device identifying one or more historical item represented by the data of historical projects of the relational database, from an authorized client device over the data communications network, processing the tracker device by the bid unit of the server device to obtain an item identification of each of the one or more historical item, the item identification is related to one or more project items of the one or more historical projects, writing a historical search request stored in the memory by the bid unit for the item identification, searching the database by the bid unit per the historical search request, for any data representing the one or more project items of the one or more historical projects, retrieving by the bid unit to the memory the data representing the one or more project items, sorting by the bid unit in the memory the data representing the one or more project items, to associate the respective data representing each project item, respectively, of the historical bids, calculating by the bid unit an average historical bid of each project item of the step of retrieving, based on the historical bids of the project item of the historical projects of the step of sorting, saving in the memory by the bid unit the average historical bid of each project item, relating in the memory by the bid unit the average historical bid of each project item to the respective project item of the historical projects, creating an historical evaluation report table of the project items and the average historical bid of each project item of the historical projects, and sending the historical evaluation report table by the server device, over the data communications network to the authorized client device.

Yet another embodiment of the invention is a program stored in a computer readable non-transitory medium processed by a computer, including a projects metadata storage unit containing data representing a new project, project items of the new project, and any prior bid of the new project and data representing one or more historical projects, project items of each historical project, and bids of each historical project, a data retrieval unit to retrieve, upon receipt of a project metadata request from an evaluation terminal over a network identifying the new project to the data retrieval unit and a retrieval authorization key, upon confirmation by the data retrieval unit that the retrieval authorization key is acceptable to the data retrieval unit, the data representing the new project, the project items of the new project, and each prior bid of the new project, if any, and a subset of the data representing one or more historical projects, projects items of the historical project, and bids of each historical project corresponding to the project items of the new project, an evaluation unit to sort the subset according to respective project item of the new project and corresponding project item of the historical projects, and each corresponding bid of the project item of the respective historical projects, and to calculate an estimated bid of each project item as an average of the corresponding bids of the project items of the historical projects, and associate the estimated bid of each project item to the respective project item of the new project, and an evaluation report unit to construct a tabularized presentation of each project item of the project and corresponding estimated bid of the project item.

### BRIEF DESCRIPTION OF THE DRAWINGS

The present invention is illustrated by way of example and not limitation in the accompanying figures, in which like references indicate similar elements, and in which:

FIG. 1 illustrates a system for bid evaluation, according to certain embodiments of the invention;

FIG. 2 illustrates a tracker device of the system, according to certain embodiments of the invention;

FIG. 3 illustrates an evaluation report of the system, according to certain embodiments of the invention;

FIG. 4 illustrates a project bid evaluation system, according to certain embodiments of the invention;

FIG. 5 illustrates a database of the system, according to certain embodiments of the invention;

FIG. 6 illustrates an account database of the system, according to certain embodiments of the invention;

FIG. 7 illustrates an evaluation service method, according to certain embodiments of the invention;

FIG. 8 illustrates a method of evaluating a bid, according to certain embodiments of the invention;

FIG. 9 illustrates a method of evaluating historical bids, according to certain embodiments of the invention;

FIG. 10 illustrates an exemplary evaluation website implementation of an evaluation system accessed by one or more evaluation terminals, according to certain embodiments of the invention;

FIG. 11 illustrates an exemplary registration page of the evaluation system, according to certain embodiments of the invention;

FIG. 12 illustrates an exemplary project page of the evaluation system, according to certain embodiments of the invention;

FIG. 13 illustrates an exemplary new project tracker device page of the evaluation system, according to certain embodiments of the invention;

FIG. 14 illustrates an exemplary bidder name page of the evaluation system, according to certain embodiments of the invention;

FIG. 15 illustrates the exemplary project page of FIG. 14 including selection of a bidder check box, according to certain embodiments of the invention;

FIG. 16 illustrates an exemplary evaluation report of the evaluation system corresponding to FIG. 15, according to certain embodiments of the invention;

FIG. 17 illustrates the exemplary bidder name page of FIG. 14 including selection of more than one bidder check box, according to certain embodiments of the invention;

FIG. 18 illustrates an exemplary resulting evaluation report corresponding to FIG. 17, according to certain embodiments of the invention;

FIG. 19 illustrates an exemplary first historical tracker device page of the evaluation system, according to certain embodiments of the invention;

FIG. 20 illustrates an exemplary historical unit price evaluation report of the evaluation system corresponding to FIG. 19, according to certain embodiments of the invention;

FIG. 21 illustrates an exemplary second historical tracker device page of the evaluation system, according to certain embodiments of the invention;

FIG. 22 illustrates an exemplary historical bidder evaluation report of the evaluation system corresponding to FIG. 21, according to certain embodiments of the invention;

FIG. 23 illustrates an exemplary third historical tracker device page of the evaluation system, according to certain embodiments of the invention;

FIGS. 24a-b illustrate an exemplary location evaluation report of the evaluation system corresponding to FIG. 23, according to certain embodiments of the invention;

FIG. 25 illustrates an exemplary fourth historical tracker device page of the evaluation system, according to certain embodiments of the invention;

FIGS. 26a-c illustrate an exemplary project unit price evaluation report of the evaluation system corresponding to FIG. 25, according to certain embodiments of the invention;

FIG. 27 illustrates an exemplary fifth historical project tracker page of the evaluation system, according to certain embodiments of the invention; and

FIG. 28 illustrates an exemplary evaluation report of the evaluation system corresponding to FIG. 27, according to certain embodiments of the invention.

### DETAILED DESCRIPTION

Those skilled in the art will understand that the following detailed description and specific examples, while disclosing preferred embodiments and certain alternatives, are given by way of illustration only and not by way of limitation. For purposes of the following detailed description and examples:

A “request for proposal” (also known as a “request for bids”) is a written notice (such as an official notice posted by a requesting agency, entity, or person), other tangible media notice, and/or data representative of such notice stored in a memory of a computer. The notice contains information representative of a project and project items of the project and an estimated money expenditure (such as an engineer estimate or the like) for the project and each project item, and constitutes a solicitation for bids to construct or supply the project with the project items.

A “project” is a road, building, real estate development, tangible property, equipment, apparatus, similar structure or a product to be constructed or supplied or a service to be provided pursuant to a request for proposal, and includes data representative of the project stored in a computer readable medium, for example, a memory of a computer. Each project includes one or more respective unit or segment of “project items”. Examples of project items, and data or information representing project items, include an item identifier, an item description, a unit of measure of the item, a quantity of the item, a unit price of the item per the unit of measure, a unit price date, an engineering estimate of the unit price (or other estimated price determined by a requestor of the project item), and a date of the engineering estimate of the unit price. For a road project, as an example, project items may include an embankment, a subgrade, a drill seeding, a curb, a road surface or segment of such road surface, a barricade or traffic sign, a material (e.g., a conduit, a mulch, a fence, a beacon, an aggregate gravel, an asphalt, a sealant, or other), an equipment (e.g., a grader, a dump truck, or other), and a labor or work measure (e.g., an excavation, a backfill, a widening, or other), and include data representative of such project item stored in a computer readable medium, such as memory of a computer.

A “bid” is a document or file responsive to a request for proposal, constituting an offer subject to acceptance for construction, supply, or provision of the relevant project, and includes data representative of such document or file and contents of the document or file stored in a computer readable medium, for example, memory of a computer. Each bid contains information representative of an offered money price of a bidder for the project and each project item of the request for proposal.

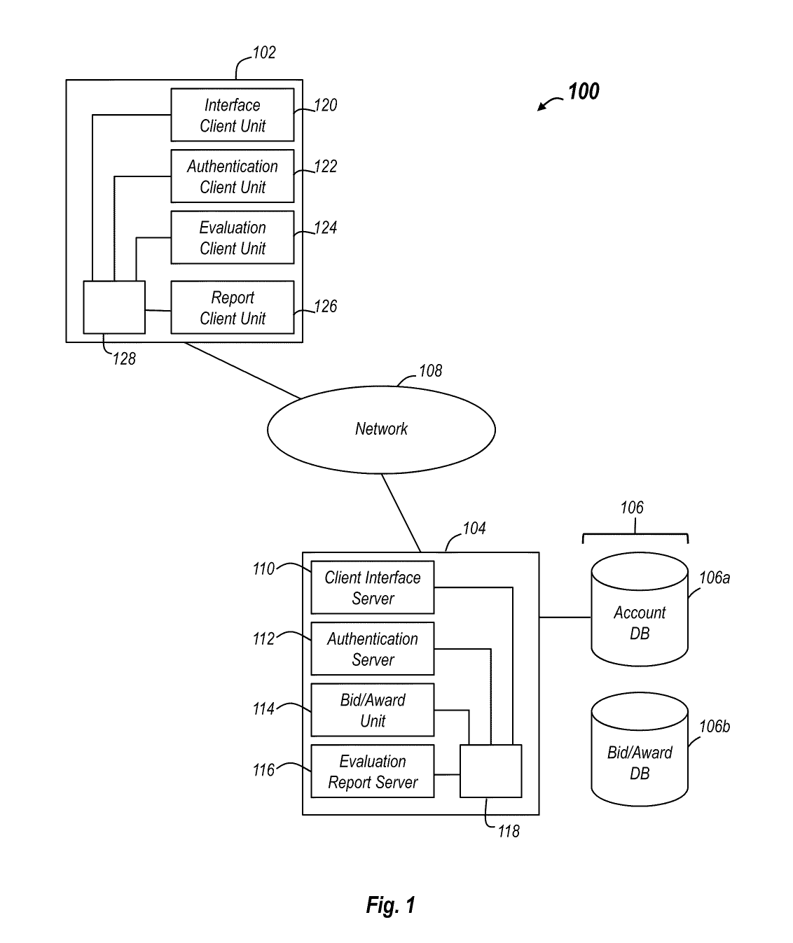

Referring to FIG. 1, an evaluation system 100 includes an evaluation server 104. The evaluation server 104 includes a client interface server 110, an authentication server 112, a bid/award unit 114, and an evaluation report server 116. The evaluation server 104 also includes a server controller 118 for controlling each of the client interface server 110, the authentication server 112, the bid/award unit 114 and the evaluation report server 116. Each of the client interface server 110, the authentication server 112, the bid/award unit 114 and the evaluation report server 116 is circuits and/or programs stored in memory of the evaluation server 104. Alternately, any or all of these can be separate devices and/or programs stored in separate memory from the evaluation server 104, communicatively connected to the evaluation server 104.

An evaluation database 106 of the system 100 includes or is communicatively or otherwise operatively connected to the evaluation server 104. The evaluation database 106 includes a client account database 106a and a bid/award database 106b, which may be separate or converged database(s). The client account database 106a contains metadata representing each authorized communication device for accessing the evaluation server 104, and includes metadata representing usage, money charges and payments, and identifiers for the authorized communication device (or, as applicable, users of the communication device) in respect of the system 100. The bid/award database 106b contains metadata representing projects, including respective project items, and bids in respect of the projects and project items. In example embodiments, the bid/award database 106b contains at least two tables of such metadata. One of the tables contains projects metadata representing “historical bids,” e.g., each project, respective project items, and respective bids related to a request for proposal for which one or more bids were previously received for the project with at least one of the bids having been accepted for the project. Another of the tables contains projects metadata representing “new/open bids,” e.g., each project and respective project items related to a request for proposal for which no bid has yet been accepted for the project, and also any bids which the requestor of the request for proposal has received in response to the request for proposal.

The evaluation server 104 of the system 100 communicatively connects to an evaluation network 108. Via the evaluation network 108, one or more authorized evaluation client terminal 102 communicatively connected to the evaluation network 108 can communicatively connect to the evaluation server 104. Each such evaluation client terminal 102 includes an interface client unit 120, an authentication client unit 122, an evaluation client unit 124, and a report client unit 126. Each evaluation client terminal 102 also includes a terminal controller 128 for controlling each of the interface client unit 120, the authentication client unit 122, the evaluation client unit 124 and the report client unit 126. Each of the interface client unit 120, the authentication client unit 122, the evaluation client unit 124 and the report client unit 126 is circuits and/or programs stored in memory (not shown in FIG. 1) of the evaluation client terminal 102.

In operation, the interface client unit 120 of the evaluation client terminal 102 communicates over the evaluation network 108 to the evaluation server 104. The client interface server 110 of the evaluation server 104 communicatively responds via the evaluation network 108 to the evaluation client terminal 102. On receiving response of the client interface server 110, the authentication client unit 122 of the evaluation client terminal 102, either automatically or through input to the evaluation client terminal 102 from a user or external source of the evaluation client terminal 102, communicatively sends a select authentication device (not shown in FIG. 1), such as a key, a name/password, or similar device, to the evaluation server 102 via the evaluation network 108.

The authentication server 112 of the evaluation server 104 receives the authentication device from the evaluation network 108. The authentication server 112 searches the account database 106a, based on the authentication device, to confirm whether the account database 106a contains any account record representing the evaluation client terminal 102. If so, the authentication server 112 calculates whether, based on the account record, the evaluation client terminal 102 is authorized to further communicate with the evaluation server 104. For example, the authentication server 112 calculates, using account records and contents for the evaluation client terminal 102, any unpaid amounts or other requirements for the evaluation client terminal 102 to further access the evaluation server 104.

If the authentication server 112 determines that the account database 106a does not contain any account record representing the evaluation client terminal 102 or that the evaluation client terminal 102 is otherwise not authorized for further communicative access to the evaluation server (for example, for deficiency of the account record), the authentication server 112 triggers the client interface server 110 to serve over the evaluation network 108 to the evaluation client terminal 102 a failure notice, an account sign-up device, an account re-instatement device, or similar file, according to design of the authentication server 112 and the client interface server 110. If, on the other hand, the authentication server 112 determines that the evaluation client terminal 102 is authorized for further communicating with the evaluation server 104, the authentication server 112 directs the bid/award unit 114 of the evaluation server 104 to communicate with the evaluation client unit 124 of the evaluation client terminal 102.

The evaluation client unit 124 of the evaluation client terminal 102 accepts or receives an evaluation instruction, such as via an input to the evaluation client terminal 102, and communicates the evaluation instruction over the evaluation network 108 to the evaluation server 104. The bid/award unit 114 of the evaluation server 104 receives the evaluation instruction from the evaluation network 108. The bid/award unit 114 transforms the evaluation instruction to a search request for controlling the bid/award database 106b. In particular, the search request controls the bid/award database 106b to retrieve to the bid/award unit 114 a subset file of records contained in the bid/award database 106b. The search request is specifically created by the bid/award unit 114, using data representative of the evaluation instruction, for retrieval of the particular subset file representing a particular project or projects related to the evaluation instruction.

The subset file is processed by the bid/award unit 114, including the bid/award unit 114 calculates conversions, estimated prices, and estimated bids of bidders of the particular project or projects related to the evaluation instruction. The bid/award unit 114 associates the calculation results to selection portions of the subset file and creates a report file. The report file is passed by the bid/award unit 114 to the evaluation report server 116 of the evaluation server 104. The evaluation report server 116 creates from the subset file a report artifact and sends the report artifact over the evaluation network 108 to the report client unit 126 of the evaluation client terminal 102. The report client unit 126 reads the report artifact and processes the report artifact creating a graphical and textual evaluation report. The evaluation report contains a project (or projects) evaluation based on the evaluation instruction of the evaluation client terminal 102, the search request created by the bid/award unit 114 using the evaluation instruction, relevant contents of the bid/award database 106b representing select project(s) and corresponding project items, and calculated conversions and estimated bids of the bid/award unit 114.

In certain exemplary embodiments of the foregoing, the interface client unit 120, the authentication client unit 122, the evaluation client unit 124, and the report client unit 126 are each implemented in the evaluation client terminal 102 via a web browser, such as a browser program stored in a computer readable medium of the evaluation client terminal 102 and processed by the terminal controller 128, on downloading to the computer readable medium of the evaluation client terminal 102 respective web pages communicatively accessed from the evaluation server 104 over the evaluation network 108. According to further exemplary embodiments, the authentication server 112 and the bid/award unit 114 of the evaluation server 104 are each one or more database manager system of the evaluation server 104, such as, for example, a database management system program stored in a computer readable medium of the evaluation server 104 and processed by the server controller 118. The client interface server 110 and the evaluation report server 116 of the evaluation server 104 are, in certain embodiments, a web server program stored in a computer readable medium of the evaluation server 104.

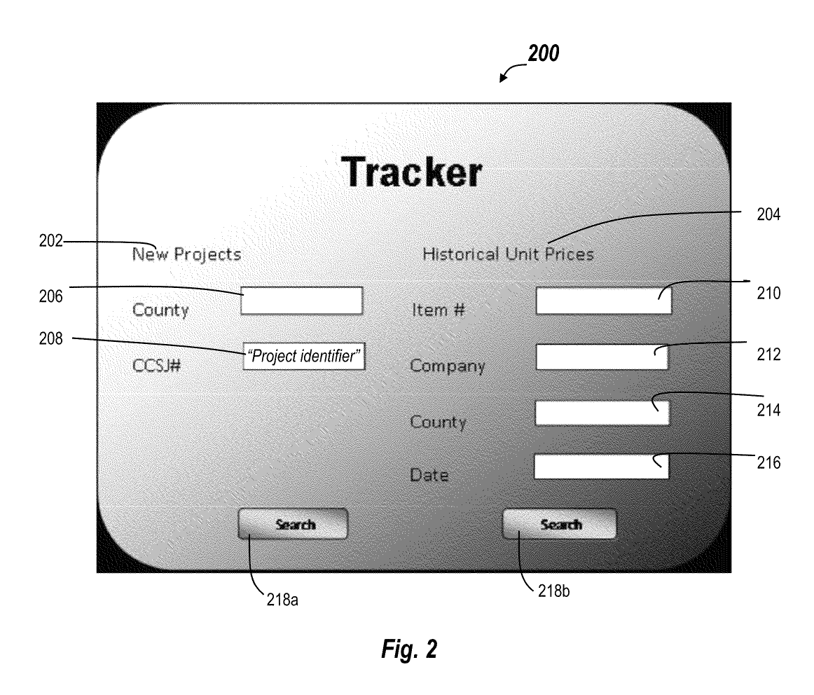

Referring to FIG. 2, in conjunction with FIG. 1, according to certain embodiments, the evaluation server 104 communicates over the evaluation network 108 to the evaluation client terminal 102, if authorized to access the evaluation server 104, a tracker device 200. The tracker device 200 accepts a data representing either a new/open bid 202 (e.g., a location identifier 206 or a project identifier 208 of the new/open bid 202) or a historical bid 204 (e.g., a project item identifier 210, a bidder identifier 212, a location identifier 214, and/or a date 216 of the historical bid 204). The tracker device 200 additionally accepts a search trigger 218a or 218b representing an instruction to the evaluation client terminal 102 to communicate the data of the new/open bid 202 or the historical bid 204, respectively, to the evaluation server 104 over the evaluation network 108. In embodiments in which the authentication client unit 122 is a web page accessed by a web browser of the evaluation client terminal 102 from the evaluation server 104, the tracker device 200 is processed by the web browser of the evaluation client terminal 102 displaying a graphic (for example, such as of FIG. 2) for receiving an input to the evaluation client terminal 102 via the web browser.

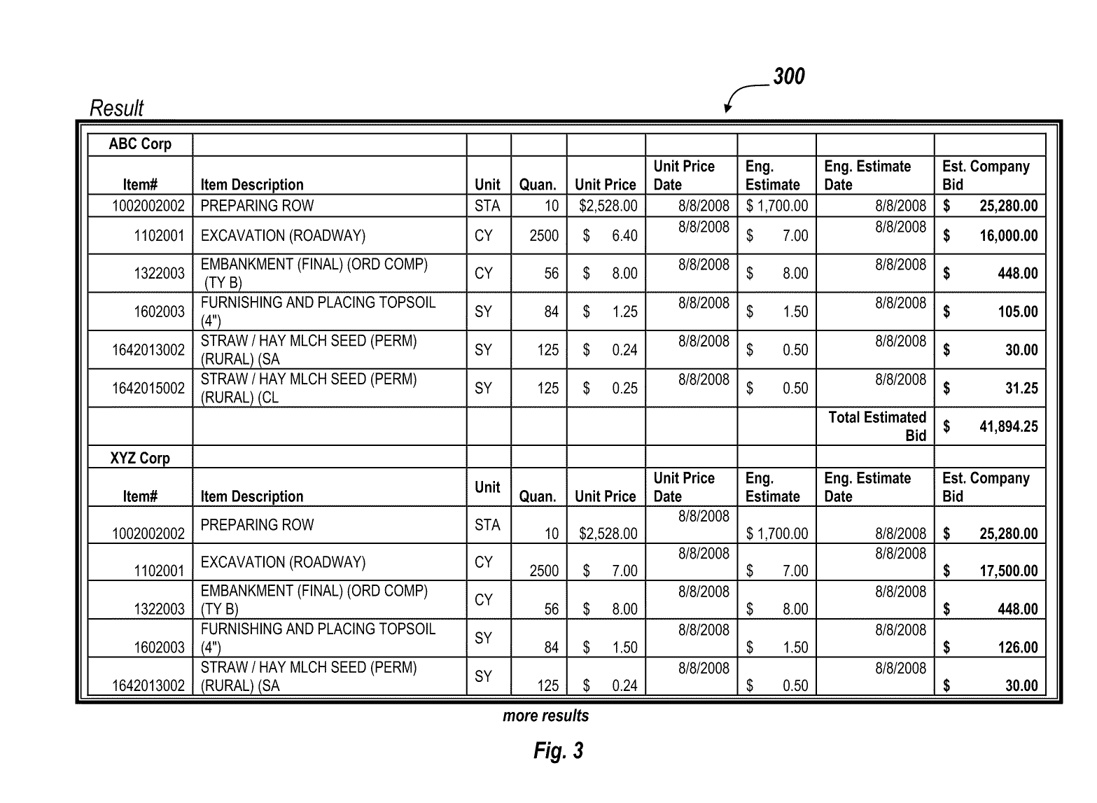

Referring to FIG. 3, in conjunction with FIGS. 1 and 2, on receiving the data of the new/open bid 202 or the historical bid 204, the bid/award unit 114 of the evaluation server 104 writes a search request, for example, a SQL language query, using the inputs of the evaluation client terminal 102 to the tracker device 200 of the new/open bid 202 or the historical bid 204. One example of the search request written by the evaluation server 104 for a historical bid 204, where the evaluation server 104 receives data representing the bidder identifier 212 input of the tracker device 200, is as follows:
SELECT “bidder identifier”, PROJECT IDENTIFIER, ITEM IDENTIFIER, ITEM DESCRIPTION, UNIT OF MEASURE, QUANTITY, UNIT PRICE, UNIT PRICE DATE, ENGINEER ESTIMATE, ENGINEER ESTIMATE DATE, TOTAL PRICE
FROM “first table and second table” of the evaluation database 106b.
   As those skilled in the art will appreciate, the foregoing search request is merely one possible embodiment. Other forms and/or formats of the search request can be written by the bid/award unit 114 of the evaluation server 104 for each unique input of the tracker device 200 by the evaluation client unit 124. For example, similar search requests are written by the bid/award unit 114 where inputs to the tracker device 200 are made by the evaluation client terminal 102 to the location identifier 206, the project identifier 208, the project item identifier 210, the location identifier 214, or the date 216, or combinations of these. As later discussed, particular search request form and format written by the bid/award unit 114 optimizes evaluations made by the evaluation server 104 for each unique evaluation client terminal 104 (and/or its user) of the system 100.

The bid/award unit 114, operated by the server controller 118, controls the evaluation database 106b to retrieve to the evaluation report server 116 a subset file of records of the evaluation database 106b. The subset file represents record contents of the bid/award database 106b corresponding to the particular “bidder identifier” and data records contained in the evaluation database 106b of historical bids related to the project(s) and project items corresponding to the bidder identifier. The bid/award unit 114 transforms the subset file by calculating project item unit conversions and pricing thereby optimally evaluating and estimating bids represented by a report file. The report file includes the calculated results associated to select portions of the subset file. The evaluation report server 116, in communication with the bid/award unit 114, translates the report file to a report artifact communicated by the evaluation server 104 on the communication network 108 to the evaluation client terminal 102. A report client unit 126 of the evaluation client terminal 102 receiving the report artifact processes the report artifact to display (or perform other operation with) an evaluation report 300. In embodiments in which the report client unit 126 is a web page accessed by a web browser of the evaluation client terminal 102 from the evaluation server 104, the evaluation report 300 as processed by the web browser of the evaluation client terminal 102 displays in the web browser a graphic and text representation of the evaluation report 300 (for example, such as of FIG. 3).

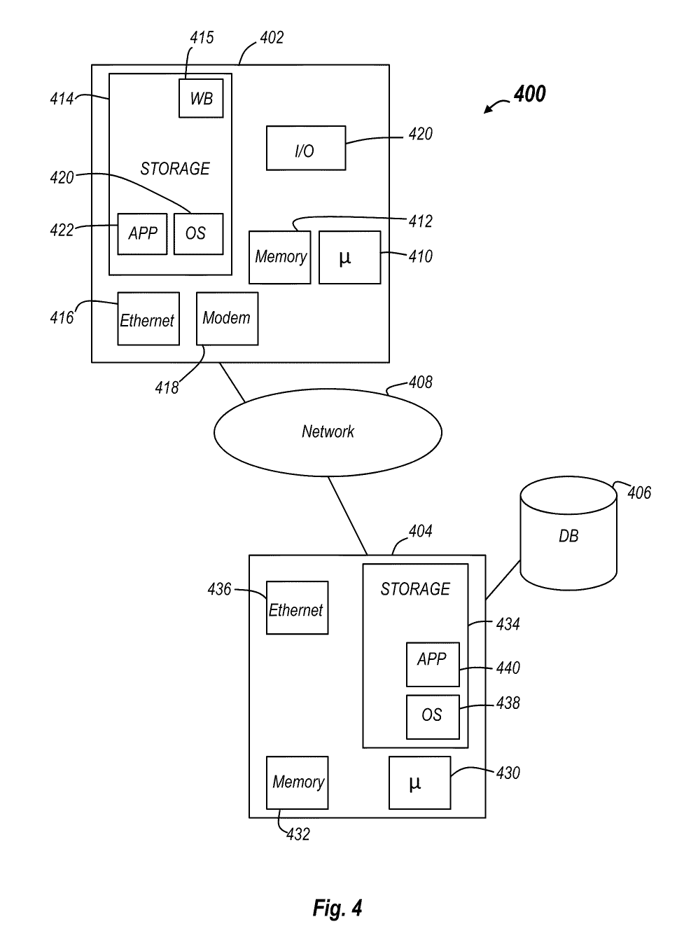

Referring to FIG. 4, an exemplary embodiment of the evaluation system 100 of FIG. 1 is a project bid evaluation system 400. The project bid evaluation system 400 includes a bid evaluation server device 404. The bid evaluation server device 404 includes, or is operatively connected to, a database 406. A client bid evaluation device 402 is capable of communicatively connecting to the bid evaluation server device 404, by a communications network 408 connected to the bid evaluation server device 404.

The client bid evaluation device (“client evaluation device”) 402 includes, or is operatively connected to, a processor 410, memory 412, storage 414, and a web browser 415. The client evaluation device 402 communicatively connects to the network 408 via a communication interface, such as an Ethernet port 416, a modem 418, a wireless link (not shown in FIG. 4), or another communicative linker, of the client evaluation device 402. The client evaluation device 402 may, but need not necessarily, additionally include or operatively connect to one or more input/output device 420, for example, a display, a printer, a keyboard, or a mouse, or another component or peripheral device. The client evaluation device 402 also includes an operating system 420, for example, circuit(s) and/or an operating system program stored in the storage 414 and/or memory 412 processed by the processor 410, to control, direct, and operate the client evaluation device 402 for bid evaluation and communications on the network 408. Additionally, but not necessarily, one or more application program 422 may be stored in the storage 414 and/or memory 412 for processing by the processor 410. In certain example embodiments, the client evaluation device 402 is a computer, such as a desktop or laptop computer, a tablet computer, a personal digital assistant device, a data capable cellular phone, or other communicative device, capable of communicating over the network 408 with the bid server device 404. Further in certain example embodiments, the web browser 415 is a hardware apparatus and/or web browser software program stored in the storage 414 and/or memory 412 and processed by the processor 410 for communicating with the bid server device 404 over the network 408. Although a single client evaluation device 402 is illustrated in FIG. 4, pluralities of such devices may concurrently communicatively connect to the network 408 for communicating with the bid evaluation server device 404.

The client evaluation device 402 is an example embodiment of the evaluation client terminal 102 of FIG. 1. With reference to FIG. 1 in conjunction with FIG. 4, the evaluation client unit 114 and the report client unit 126 are each circuits and/or program stored in the storage 414 or memory 412 of the client evaluation device 402 and operated by the processor 410. According to certain embodiments, the evaluation client unit 114 and the report client unit 126 are the web browser 415. In such embodiments, the evaluation client unit 114 and the report client unit 126 are respective graphical web pages loaded to the web browser 415 from the bid evaluation server device 404 over the network 408 and processed by the web browser 415. The web page(s) processed by the evaluation client unit 114 includes, for example, the tracker device 200. Further in such embodiments, the report client unit 126 is operated by the terminal controller 128 responsive to receiving a report artifact from the evaluation server 104 via the network 108. The report client unit 126 creates and outputs an evaluation report through processing of the report artifact, such as the evaluation report 300 processed by the web browser 415 for display and input interaction.

The bid evaluation server device (“evaluation server device”) 404 includes, or is operatively connected to, a processor 430, memory 432, storage 434, and the bid database 406. The evaluation server device 404 communicatively connects to the network 408 via a communication interface, such as an Ethernet port 436 or other communicative linker, of the evaluation server device 404. The evaluation server device 404 may, but need not necessarily, additionally include or operatively connect to one or more other input/output device, for example, an administrator display, a keyboard, or a mouse, or other apparatus or peripheral device. The evaluation server device 404 includes a server operating system 438, for example, circuit(s) and/or a server operating system program stored in the storage 434 and/or memory 432 processed by the processor 430, to control, direct, and operate the evaluation server device 404 for communicating in response to requests from authorized communication devices (such as the client evaluation device 402) over the network 408. The evaluation server device 404 also includes, or is operatively connected to, a bid database manager system 440. In certain example embodiments, the bid database manager system 440 is a hardware database manager and/or database management program stored in the storage 434 and/or memory 432, processed by or operatively connected to the processor 430 for controlling the bid database 406. Although a single evaluation server device 404 is illustrated in FIG. 4, the evaluation server device 404 can be one or more such server apparatus, as may be required or desired for communicating with pluralities of communication devices (such as the client evaluation device 402) over the network 408 or other communicative links between those communication devices and the evaluation server device 404.

The evaluation server device 404 is an example embodiment of the evaluation server 104 of FIG. 1. With reference to FIG. 1 in conjunction with FIG. 4, the bid/award unit 114 and the evaluation report server 116 are each circuits and/or programs stored in the storage 434 or memory 432 of the evaluation server device 404 and operated by the server controller 430. According to certain embodiments, the bid/award unit 114 is the bid database manager system 440. The bid/award unit 114 in such embodiments is operated by the evaluation controller 118 responsive to receipt by the evaluation server 104 from the evaluation network 108 of data representing the new/open bid 202 or the historical bid 204, such as via operation of the tracker device 200 of the evaluation client terminal 102. Further in such embodiments, the evaluation report server 116 is operated by the evaluation controller 118 responsive to the bid/award unit 114 on retrieving from the evaluation database 106b a select subset result representing contents of the bid/award database 106b corresponding to data records related to the new/open bid 202 or the historical bid(s) 204, as applicable. The bid/award unit 114, based on the data representing the new/open bid 202 or the historical bid(s) 204 (or particular content thereof) as received by the evaluation server 104, writes a search query to the memory 432 and controls the bid database 406 and retrieves the select subset result according to the particular search query. The select subset result represents historical bids 204 relevant to a new/open bid 202 and the project and project items of the new/open bid 202. The bid/award unit 114 transforms the select subset result, including by calculating project item unit conversions and estimated prices of bids and associating the calculations to the new/open bid 202, to a report file of portions of the select subset result and calculated results of the bid/award unit 114. The evaluation report server 116 obtains the report file from the bid/award unit 114, creates a report artifact representing the report file, and communicates the report artifact over the evaluation network 108 to the evaluation client terminal 102.

The bid database 406 is a computer readable medium storage unit and/or a software program stored in a computer readable medium, for collecting and holding data representative of new/open bids and historical bids, including related project(s), and prices of bids of project(s) and project items. The bid database 406 contains at least two tables. One of the at least two tables of the bid database 406 contains metadata representing new/open bid items (i.e., each project related to a request for proposal for which no bid has yet been accepted for the project). For example, for each open bid item, the bid database 406 contains data representing a project identifier(s), project location, the project requestor's estimate of its expected cost for the project (e.g., engineer's estimate), itemized identifier(s) and/or description(s) of each specific activity, material, or good of the request, units of measure for each such activity, material or good, quantity of each such activity, material or good requested, bids then received for the project by the requestor of the request for proposal, and the like. Another of the at least two tables of the bid database 406 contains metadata representing historical bid items (i.e., each project related to a request for proposal for which one or more bids were previously received for the project with at least one of the bids having been accepted for the project. For example, for each historical bid item, the bid database 406 contains data representing a project identifier(s), the project location, the project requestor's estimate of its expected cost for the project (e.g., engineer's estimate), itemized identifier(s) and/or description(s) of each specific activity, material, or good of the request, units of measure for each such activity, material or good, quantity of each such activity, material or good requested, and total and itemized bid price of the received bids for the project. In certain example embodiments, the bid database 406 is a relational database program stored in the storage 434 of the evaluation server device 404 and processed by the processor 430, such as a SQL database. Alternatively, the bid database 406 can include a relational or other database program stored in a separate data storage operatively connected to the evaluation server device 404 or operatively connected to a different processor and communicatively linked to the evaluation server device 404. The evaluation database 406 is an example embodiment of the bid/award database 106b of FIG. 1.

The communications network 408 is any communications link or combination of such links, such as a wired, wireless, other communicative link, or combinations, capable of communicatively connecting the client evaluation device 402 and the evaluation server device 404. In certain embodiments, the network 408 is a communicative link or links of a data network, for example, a public or private digital packet-switched network, dedicated network, switched circuit network, virtual network, terrestrial or satellite wireless data network, or combinations of any of these. Examples of communicative links of the network 408 include the Internet, a wide area network, a local area network, a virtual private network, a dedicated link network, a wireless data network, bus, optic fiber, coaxial cable, twisted pair or other communicative link, or combinations of any of these. The network 408 may, but need not necessarily, include intermediary points, nodes, devices, or apparatus interconnecting communicative links, and/or other networks or sub-networks, as well as additional network communication devices. The evaluation network 408 is an example embodiment of the communications network 108 of FIG. 1.

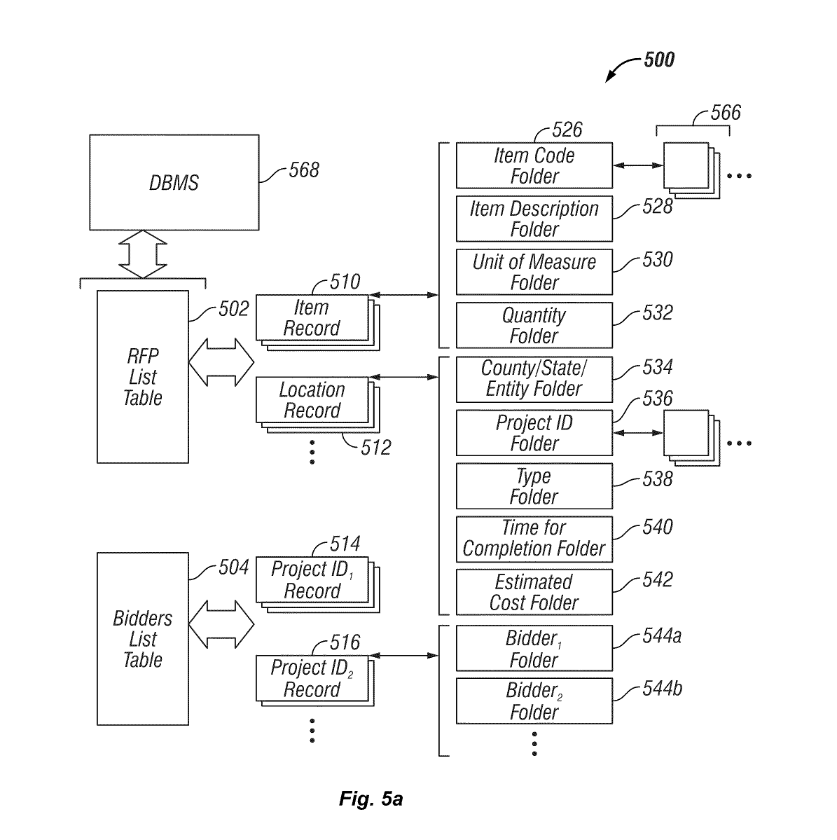

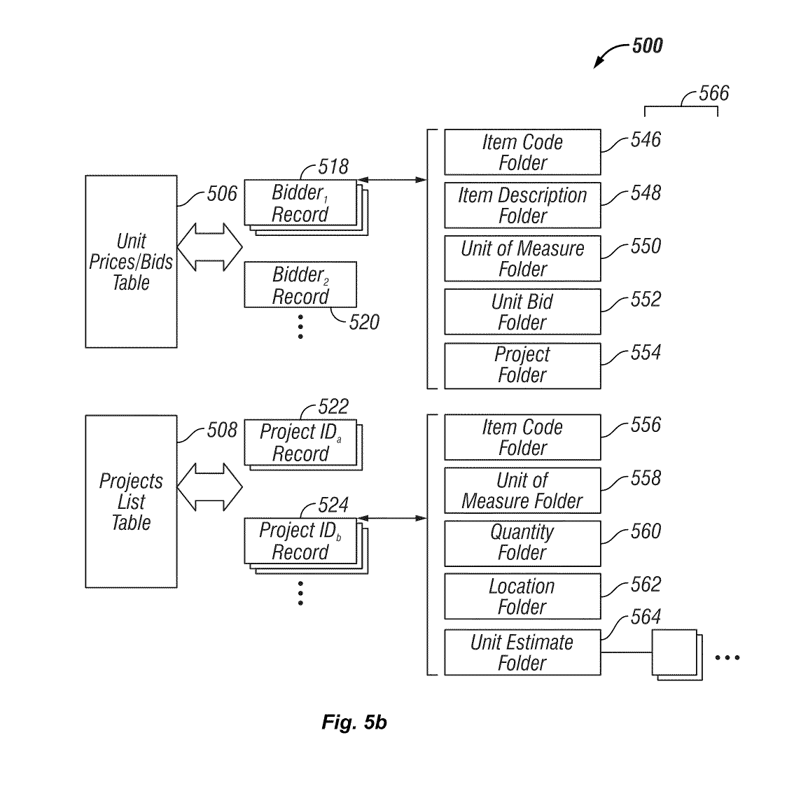

Referring to FIG. 5 in conjunction with FIGS. 4 and 1, a database 500 is an exemplary embodiment of the bid database 406 of FIG. 4 and the bid/award database 106b of FIG. 1. The database 500 contains four tables—a request for proposal table 502, a bidders table 504, a unit prices/bids table 506, and a project table 508. The request for proposal table 502 and the bidders table 504 represent new/open bids, e.g., each project, and respective project items, related to a request for proposal for which no bid has yet been accepted/awarded for the project by the project requestor (although one or more bid may have been received by the project requestor). The unit prices/bids table 506 and the project table 508 represent historical bids, e.g., each project, and respective project items, related to a request for proposal for which one or more bids were previously received for the project with at least one of the bids having been accepted/awarded for the project by the project requestor.

The request for proposal table 502 contains metadata representing one or more request for proposal of a requestor of new/open bids of new projects, for example, respective new project item records 510 and corresponding new project location records 512 for each project of the new/open bids. The new project item records 510 contain one or more folders, such as a new project item code folder 526, a new project item description folder 528, a new project unit of measure folder 530, and a new project quantity folder 532. Each new project item code folder 526 contains metadata representing one or more identifier of a project item. The new project item description folders 528 each contain data representing a descriptor of a respective project item, such as graphical, textual or multimedia information related or corresponding to the project item. The new project unit of measure folders 530 each contain data representing a measure, for example, distance, weight or other measurement unit, applicable to a respective project item. Each new project quantity folder 532 contains data representing fulfillment quantities of the project item. The new project location records 512 also contain one or more folders, such as a new entity folder 534, a new project identification folder 536, a new project type folder 538, a new project completion folder 530, and a new project estimated cost folder 540. The new entity folder 534 contains metadata representing a requestor of a request for proposal of new/open bids of the project. Each new project identification folder 536 contains data representing a project identifier of a requestor for the project of the new/open bids, such as a requestor's identification number or designation corresponding to the project and request for proposal. The new project type folder 538 contains metadata representing a categorization of the project, for example, a roadway, a particular structure, a building, a particular equipment or product, or other. Data representing a requestor's requirement for completion date and/or timing of a project is contained in respective new project completion folders 530. Each new project estimated cost folder 540 contains data representing a requestor's estimate of cost for obtaining the project item.

The bidders table 504 contains metadata representing one or more requestor of a request for proposal of new/open bids of projects, for example, respective new project identifier records 514, 516. Each new project identifier record 514, 516, if a bid has been placed for a project of a request for proposal, contains at least one new project bidder folder 544a, 544b. Each new project bidder folder 544a or 544b contains metadata representing a bidder responding to a request for proposal with a bid for the relevant project.

The unit prices/bid table 506 contains metadata representing each bid having been previously received in response to a request for proposal of past projects, for example, one or more respective bidder record 518, 520. Each bidder record 518, 520 contains one or more folders, such as an item code folder 546, an item description folder 548, a unit of measure folder 550, a unit bid folder 552, and a project folder 554. Each item code folder 546 contains data representing a number or identifier assigned by a request for proposal for a project item. The item description folders 548 each contain data representing a descriptor of a respective project item, such as graphical, textual or multimedia file related or corresponding to the project item. The unit of measure folders 550 respectively contain data representing a measure, for example, distance, weight or other measurement unit, applicable to a respective project item. Each unit bid folder 552 contains data representing an offer price of a bidder for providing a project item. The project folders 554 each contain metadata representing respective project, and related project items, of projects of historical bids, for example, identifiers of the project, special or specific requirements, location, quantities, and other similar items related to a request for proposal for the project and project items.

The projects table 508 contains metadata representing each project and respective request for proposal of a project of historical bid(s). The projects table 508, for example, contains project records 522, 524 for the project of the historical bids. Each project record 524 or 522 contains one or more folders, for example, an item code folder 556, a unit of measure folder 558, a quantity folder 560, a location folder 562 and a unit estimate folder 564. The item code folders 556 each contain metadata representing one or more identifier of a project item. Each unit of measure folder 558 contains data representing a measure, for example, distance, weight or other measurement unit, for a project item. Each quantity folder 560 contains data representative of fulfillment quantity required for a project item. The location folders 562 each contain metadata representing a geographic locale or point of a project, such as a state, county, city or other location of the project. Each unit estimate folder 564 contains data representing a requestor's estimate (e.g., engineer's estimate) of cost in a request for proposal for obtaining a project item of the project.

The database 500 may include additional files 566 corresponding to respective folders, such as files 566 containing data representative of identifiers of project items of item code folders 526, project identifiers of requestors for projects of project identification folders 536, cost estimates of project items of unit estimate folders 564, and/or other files. Because the database 500 has a relational schema, contents of various tables, records, folders, and files, as applicable, are correspondingly indexed for interrelatedness. A database management system 568 controls the database 500. The database management system 568 is, for example, a database management system program stored in a computer readable medium and processed by a controller, such as the evaluation controller 118 of FIG. 1, the server controller 430 of FIG. 4, or other processor connected to the database 500 and the database management system 568.

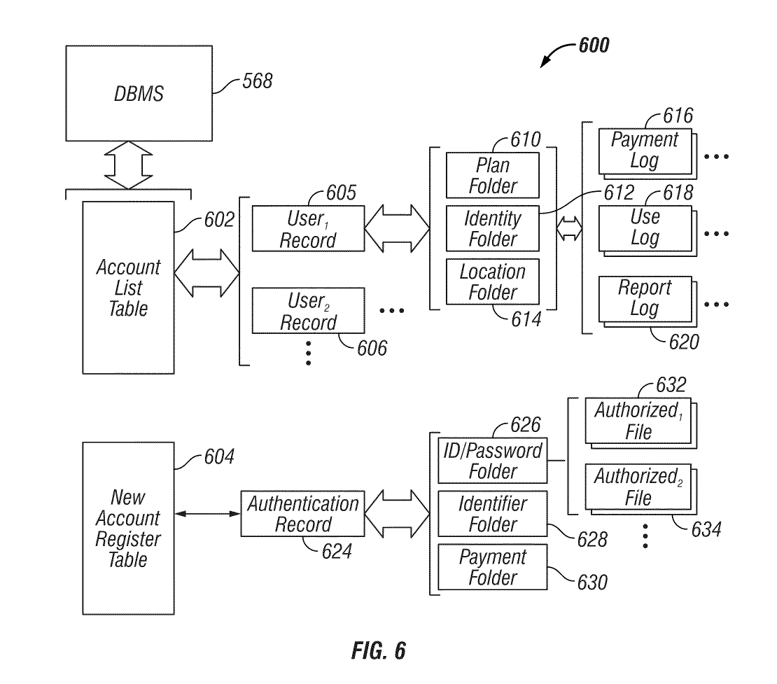

Referring to FIG. 6, in conjunction with FIGS. 1 and 4, a user account database 600 is an exemplary embodiment of the account database 106a of FIG. 1 and, if desired in the system 400, is included in the database 406 or otherwise communicatively connected to the server device 404 of FIG. 4. The user account database 600 contains an accounts table 602 and a new register table 604. The new register table 604 represents devices (and users of the devices), such as the client evaluation terminal 102 of FIG. 1 or the client evaluation device 402 of FIG. 4, when first establishing an account of a device (and/or user of the device) for authorized access of the system 100 or 400, as applicable. The accounts table 602 represents a registered user account of an authorized device (and/or user of the device), such as the client evaluation terminal 102 or the client evaluation device 402, after the device (and/or user) has established an account for authorized access of the system 100 or 400.

The new register table 604 contains a respective authentication record 624 for each client evaluation terminal 102 or client evaluation device 402, as applicable. Each authentication record 624 contains at least a name/password folder 626, an identifier folder 628 and a payment folder 630. The name/password folder 626 contains data representing a key, such as a name and password, for authorized access of the system 100 or 400 by the client evaluation terminal 102 or client evaluation device 402. Respective name and password files 632, 634 can be maintained by the name/password folder 626, such as for more than one client device and/or user of client device(s) authorized to access the system 100 or 400. The identifier folder 628 contains data representing an identity of the client evaluation terminal 102 or client evaluation device 402, and/or authorized user(s) thereof, including name, address, and similar identifiers and contact, location, and mailing/billing information. Upon initially accessing the evaluation server 104 or evaluation server device 404 via the network 108 or 408, a client device must register to obtain authorization for further access of the system 100, 400. The client device registers by establishing in the new register table 604 an authentication record 624 for the client device. The client device is thereafter authorized for operating as the client evaluation terminal 102 or client evaluation device 402, as applicable, for accessing the database 500 via the evaluation server 104 or evaluation server device 404, respectively.

Once the authentication record 624 is established in the new register table 604, a corresponding user record 605 for each respective user of the authorized client evaluation terminal 102 or client evaluation device 402, as applicable (“client device”), is created by the database management system 568 in the account table 602. Each user record 605, 606 contains a plan folder 610, an identity folder 612, and a location folder 614 of a respective user authorized for the client device in the system 100 or 400. The plan folder 610 contains metadata representing a payment and usage plan for the user of the client device, selectable by input to the client device on initial access or periodically updatable thereafter by change to account settings for the client device maintained in the database 600. The identity folder 612 contains a respective user name and password for authorized access by the client device in the system 100 or 400 by a user operating the client device. The location folder 614 contains an identifier of a location of the client device and/or its user, such as an Internet Protocol (IP) address or other locator for the client device and/or user. The plan folder 610, identity folder 612 and/or location folder 614 include various logs, such as a payment log 616 of data representing a payment and receivables history for the client device and/or user in the system 100 or 400, a use log 618 of data representing a system usage history for the client device and/or user, and report log 620 of data representing a history of evaluation reports obtained by the client device and/or user in the system 100 or 400.

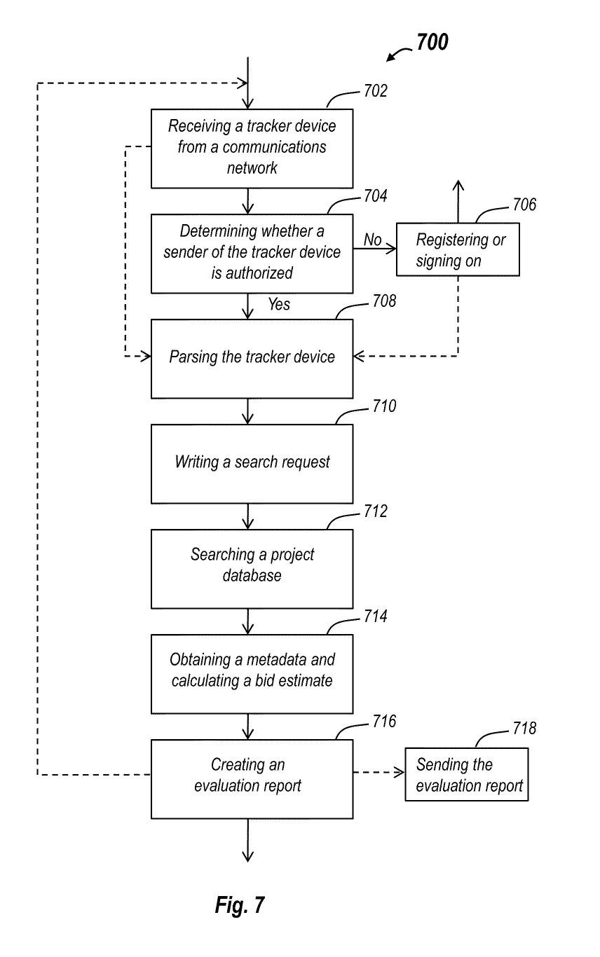

Referring to FIG. 7, an evaluation service method 700, for example, such as may be performed by the systems 100 and 400, includes receiving 702 a tracker device from a communications network. An evaluation server, for example, receives in the step 702 the tracker device communicated by an evaluation terminal over the communications network connected to the evaluation terminal and the evaluation server. According to certain embodiments, the evaluation terminal accesses a website related to or maintained at the evaluation server. The website accepts input of the tracker device from the evaluation terminal and the evaluation terminal sends the tracker device, via a send button, over the network to the evaluation server.

The evaluation server receiving the tracker device in the step 702 determines if a sender of the tracker device is authorized for further access to the evaluation server in the method 700. The evaluation server, for example, searches a memory of sign-ins of or communicatively connected to the evaluation server to determine if the evaluation terminal is then authorized through name and password communicated by the evaluation terminal to the evaluation server over the network. If the evaluation terminal is not then authorized according to the memory of sign-ins, the evaluation server communicates over the network to the evaluation terminal for steps of registering or signing-in 706 in communication of the evaluation server with the evaluation terminal. The step 706 requires receipt by the evaluation server from the evaluation terminal of either: a sign-in name and password, if the evaluation terminal and its user have previously registered an account via the evaluation server; or a new account registration, if the evaluation terminal and/or its user have not previously registered an account via the evaluation server.

If the evaluation terminal is then authorized per the memory of sign-ins, or once the evaluation terminal has become authorized through the step 706, the evaluation server parses the tracker device in a step 708. Parsing 706 of the tracker device obtains data representing either a new/open bid or one or more historical bid.

New/Open Bids:

If the parsing 706 of the tracker device obtains data representing a new/open bid, the evaluation server writes a search request in a step 710 corresponding to the new/open bid. According to certain example embodiments, the evaluation server creates a search request of the following form:

```
SELECT “project identifier”, BIDDER IDENTIFIER,
    ITEM IDENTIFIER, ITEM DESCRIPTION, UNIT OF MEASURE,
    QUANTITY, UNIT PRICE, UNIT PRICE DATE, ENGINEER
    ESTIMATE, ENGINEER ESTIMATE DATE, TOTAL PRICE
FROM a projects database.
```

The evaluation server must obtain from the parse 706 at least data representing a project identifier (e.g., a project identification name or number of a request for proposal for the project) in respect of the new/open bid. In certain exemplary embodiments, the evaluation server obtains from the parse 706 of the tracker device a project location and the project identifier for the project location; the website access by the evaluation terminal for communication with the evaluation server allows a user of the evaluation terminal to input via the evaluation terminal to the website a location of interest for project(s) of new/open bids, such as a county name, and the website includes a drop-down menu for selection of a particular name or identifier of a then-current new/open bid from among projects of the location, for selection by the evaluation terminal of a particular new/open bid for communication to the evaluation server via the tracker device.

Historical Bids:

If the parsing 706, however, obtains data representing one or more historical bid, the evaluation server writes the search request in the step 710 corresponding to the historical bid. According to certain example embodiments:

For data from the parse 706 representing a project item (e.g., a name or number for a project item of historic projects, such as an excavation, a curb cut, or other specific portion of historic projects, specified by the request for proposal), the evaluation server creates the search request of the following form:

```
SELECT “project item”, PROJECT IDENTIFIER, ITEM IDENTIFIER,
    ITEM DESCRIPTION, BIDDER IDENTIFIER, PROJECT
    LOCATION, QUANTITY, UNIT PRICE, UNIT PRICE DATE
FROM the projects database.
```

For data from the parse 706 representing a bidder identifier (e.g., a name or identity of a company or person submitting a bid in response to one or more request for proposal for historic projects), the evaluation server creates the search request of the following form:

```
SELECT “bidder identifier”, PROJECT IDENTIFIER, ITEM
    IDENTIFIER, ITEM DESCRIPTION, PROJECT LOCATION,
    QUANTITY, UNIT PRICE, UNIT PRICE DATE
FROM the projects database.
```

For data from the parse 706 representing a project location (e.g., a state, county, city or other locator of historic projects), the evaluation server creates the search request of the following form:

SELECT “project location”, ITEM IDENTIFIER, ITEM DESCRIPTION,
UNIT OF MEASURE, QUANTITY, UNIT PRICE
FROM the projects database.

For data from the parse 706 representing a project identifier (e.g., a project identification name or number of a respective request for proposal for a particular historic project), the evaluation server creates the search request of the following form:

SELECT “project identifier”, ITEM IDENTIFIER, ITEM DESCRIPTION,
UNIT OF MEASURE, QUANTITY, UNIT PRICE
FROM the projects database.

The search request created by the evaluation server in each instance can additionally, but need not necessarily, include limits for date or date range, if date(s) are selected by a user of the evaluation terminal, received by the evaluation server via the tracker device, and data obtained from the parsing 706 by the evaluation server corresponds to the date limits. In certain exemplary embodiments, the evaluation server obtains from the parse 706 of the tracker device a plurality of data representing more than one of the project item, bidder identifier, project location, and project identifier (and, additionally, possibly a data representing the date limits). In such instance, the evaluation server determines that the plurality of data is obtained and creates the search request to include “SELECT” fields for each such respective data, but without duplication of selection fields.

In a step 712, the evaluation server searches a project database communicatively or otherwise operatively connected to the evaluation server. The project database is, for example, the evaluation database 106b of FIG. 1, the database 406 of FIG. 4, the database 500 of FIG. 5, or similar database containing projects metadata representing historical bids and new/open bids. If data from the parsing step 708 represents a new/open bid, the evaluation server writes the search request in the step 710 of form for the new/open bid and searches in the step 712 according to the search request. If data from the parsing step 708 represents one or more historical bid, the evaluation server instead writes the search request in the step 710 of form for the historical bid(s) and searches in the step 712 according to the search request.

In a step 714, the evaluation server obtains from the step of searching 712 a set of metadata representing one or more project and transforms at least certain of the set, for example, calculating average and estimated bids for each project item of the project(s), each bidder for the project(s), unit of measure conversion for the project(s), and other evaluation items of the project (s), such as a total estimated bid of each bidder.

New/Open Bid Search:

For example, where the search request regards a new/open bid of a project, the set of metadata obtained in the step 714 represents, for the project, each bidder, each project item of the project per the bidder's bid, description of each project item, unit of measure of each project item, quantity of each project item, and any estimated cost and date of estimate related to the new/open bid. The set of metadata also represents each same project item of historical bid(s) of the same bidders, as well as the unit price of the project item of the historical bid.

The evaluation server calculates, in the step 714, an average unit price based on the unit price of each project item of the historical bid(s) of each bidder, respectively. The evaluation server calculates conversions, as may be required, to accord the unit of measure on which each unit price is based for each project item of the historical bid(s) with the unit of measure per the new/open bid of the project item. Alternately, the evaluation server calculates unit price from metadata of the set representing prior bid(s) by the respective bidder, to determine a highest, lowest or most recent unit price of each project item per the unit of measure of the new/open bid of the project item. In certain embodiments, the evaluation server calculates the unit price as controlled via communications received by the evaluation server from an evaluation terminal, such as through interactive communications by the evaluation terminal with the evaluation server through a website of the evaluation server.

Historical Bid Search:

In another example, where the search request regards one or more historical bid, the set of metadata obtained in the step 714 includes data representing project identity, project item(s), project item description(s), bidder(s), project location, quantity of each project item, unit of measure of the project item, unit price of the project item, and date of the historical bid of the unit price, of the project of each historical bid relevant to the search request. The evaluation server calculates conversions, as may be required, for consistency of the unit of measure on which each unit price is based for each project item of the historical bid(s). The evaluation server also calculates, in the step 714, an average quantity of each project item per the unit of measure (from the conversion calculation, as applicable). Further in the step 714, the evaluation server calculates an average unit price of each project item based on the average quantity of each project item per the consistent unit of measure of the project item.

In a step 716, the evaluation server transforms the results of the steps 712 and 714 to an evaluation report readable and displayable as a graphical and textual report by an evaluation terminal, for example, an evaluation report processed and displayed by a web browser of the evaluation terminal. The graphical and textual report represents an optimal evaluation of expected, likely, and/or anticipated bids constructed from historical bids. Particularly, the evaluation report when read and displayed by the evaluation terminal optimally compares pricing, on a project and per project item basis, of each relevant historical bid on an individual bidder basis.

If applicable in the embodiment, the evaluation server, in a step 718, can communicate the evaluation report, or a communicated artifact thereof, over a communications network. In the step 718, the evaluation report is communicated, for example, over the communications network to the authorized evaluation terminal which communicated the tracker device received by the evaluation server in the step 702.

The method 700 can return to the step 702 for any next evaluation process according to the method 700. The evaluation server receives in the step 702 a next tracker device of the same authorized sender from the communications network. The method 700 proceeds to the step 708 of the method 700, unless the sender has logged-out or otherwise is not authorized to continue the method 700 for the next evaluation process.

Referring back to FIG. 1 in conjunction with FIG. 7, in operation of the system 100 in accordance with the method 700, the client interface server 110 of the evaluation server 104, in the step 702, receives from the network 108 the tracker device communicated on the network 108 by the interface client unit 120 of the evaluation client terminal 102. The client interface server 110 detects the tracker device as being received and, in the step 704, commences the authentication server 112 of the evaluation server 104 to communicate over the network 102 with the authentication client unit 122 of the evaluation client terminal 102 for determination if the evaluation client terminal 102 is authorized in the system 100. If the authentication server 112 determines in the step 704 that the evaluation client terminal 102 is authorized, the method proceeds to the step 708. If, however, the evaluation client terminal 102 is not then authorized, either because first accessing the authentication server 112 or because previously authorized but then logged-out from the authentication server 112, the authentication client unit 122, in communication with the authentication server 112, must in the step 706 either automatically or via input of a user of the authentication client unit 122 communicate to the authentication server 112 a log-in key, such as a name and password, or register for access and obtain the log-in key for communication. If the authentication server 112 receives the log-in key, either because automatically or through input (i.e., sign-on and/or registration) communicated by the authentication client unit 122, the method 700 proceeds to the step 708. If the log-in key is not received by the authentication server 112 in the step 706, the evaluation client terminal 102 is no longer included in the system 100 and the method 700 discontinues.

If the method 700 proceeds from the step 706 to the step 708, the bid/award unit 114 of the evaluation server 104 obtains and parses the tracker device in the step 708. Based on the result of the parse step 708, the bid/award unit 114 writes the search request in the step 710. In the step 712, the bid/award unit 114 queries the bid/award database 106b according to the search request. On completion of the step 712, the bid/award unit 114 obtains the metadata of the database 106b corresponding to the search request in the step 714. Also in the step 714, the bid/award unit 114 calculates one or more bid estimate based on consistent unit of measure to obtain an estimate of average unit price for each project item and each project bidder of each respective bid (i.e., either historical bid(s) or new/open bid(s), as applicable per the search request).

In the step 716 of the method 700, the evaluation report server 116 of the evaluation server 104 transforms the results of the steps 712 and 714 to an evaluation report readable and displayable as a graphical and textual report by an evaluation client unit 124 of the evaluation client terminal 102. In the step 718, the evaluation report server 116 communicates an artifact representing the evaluation report over the network 108 for receipt by the report client unit 126 of the evaluation client terminal 102. On receipt of the artifact, the report client unit 126 displays or otherwise processes the artifact to obtain a bid evaluation report.

The method 700 can thereafter continue by return to the step 702, or otherwise the method 700 discontinues. If the method 700 continues by return to the step 702, the client interface server 110 of the evaluation server 104 receives a next tracker device from the network 108 in the step 702. This next tracker device, for example, is communicated by the evaluation client unit 124 of the evaluation client terminal 102, such as through input by a user of the evaluation client unit 124 to the evaluation client terminal 102 and directive to the evaluation client unit 124 to communicate with the client interface server 110 of the evaluation server 104. If the sender of that next tracker device (e.g., the evaluation client terminal 102) has not logged-out from the authentication server 112 or has not otherwise been de-authorized for the method 700, the method 700 continues from the step 702 to the step 708. The steps 708, 710, 712, 714, and 716, and if applicable, the step 718, then follow. The method 700 continues repeating in such manner until exited (e.g., by log-out of the evaluation client terminal 102, time out of communication with the evaluation server 104, by direction of the evaluation server 104, or as may otherwise apply according to design). The method 700 creates a respective evaluation report unique to each tracker device, and the corresponding bid evaluation report is displayable or otherwise processable by the authorized report client unit 126.

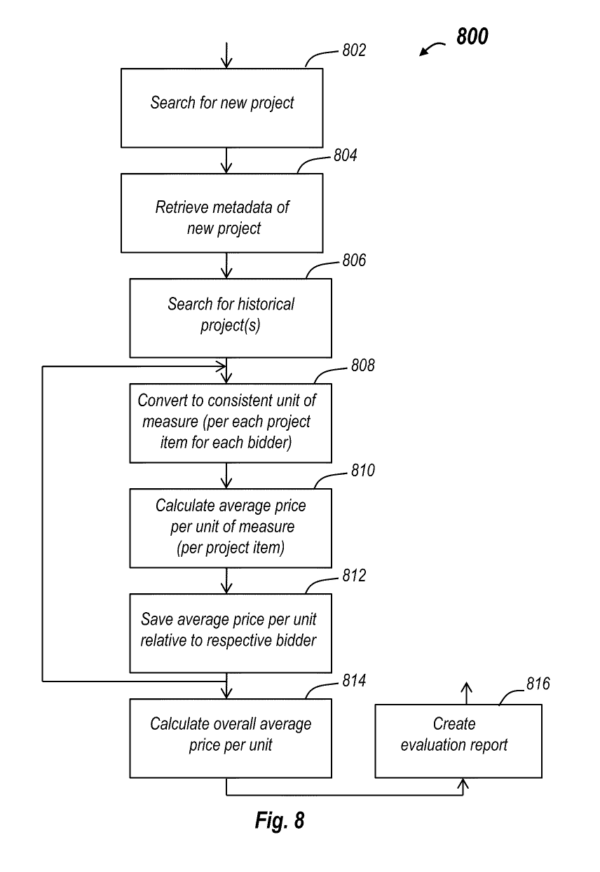

Referring to FIG. 8, a method 800 of evaluating a new/open bid is performed by the evaluation server 104 in conjunction with the bid/award database 106b. The method 800 is an exemplary embodiment of further details of operations of the bid/award unit 114 and the evaluation report server 116 of the evaluation server 104 in the steps 712, 714, 716 and 718 of the method 700 of FIG. 7 with respect to a new/open bid. In a step 802 of the method 800, the bid/award unit 114 searches the bid/award database via a search request for the new/open bid. The bid/award unit 114 retrieves a result of the search step 802 in a step 804. At least a portion of the result retrieved in the step 804 is metadata of the database 106b representing a project of the new/open bid (including bidder(s) identifier, project items, units of measure, quantities, engineer estimate and estimate date). If the database 106b contains data representing one or more projects of historical bids of same bidder(s) identifier and project items, the bid/award unit 114 searches and obtains in the step 806 another portion of the result which is metadata of the database 106b representing relevant projects of the historical bids (including for same bidder(s), project items, unit prices of the project items, unit price dates, units of measure, and quantities).

In a step 808, the bid/award unit 114 processes the result from the steps 802, 804 and 806, correlating in storage of the evaluation server 104 each project, and respective project items and other metadata, and calculates conversions for all units of measure of project items of the metadata for the historical bids for consistency with the units of measure of same project items of the metadata for the new/open bid. The bid/award unit 114 stores the calculation result in storage of the evaluation server 104. In a step 810, the bid/award unit calculates an average price per the consistent unit of measure for each project item of the metadata for the new/open bid, based on the unit prices and units of measure for same project item of the metadata for the historical bids. The bid/award unit 114 stores the calculated averages in storage of the evaluation server 104.

The bid/award unit 114 correlates the respective calculated consistent units of measure and average prices and relates these to respective project items of the new/open bid for each of the bidder identifiers of the new/open bids. Steps 808, 810 and 812 are performed as to each unique project item of the new/open bid for each of the bidder identifiers. In a step 814, the bid/award unit 114 multiplies each average unit price for each project item for each bidder by the quantity of the project item of the new/open bid, to obtain and save in storage of the evaluation server 104 an average evaluated price for each project item for each bidder. Also in the step 814, the bid/award unit 114 sums the total of all average evaluated price for each project item for each bidder, to obtain and save in storage of the evaluation server 104 an evaluated estimate total for each bidder for the project of the new/open bid. Further in the step 814, the bid/award unit 114 calculates an average overall total for all bidders for the project of the new/open bid.

In a step 816, the evaluation report server 116 of the evaluation server 104 creates an evaluation report artifact for communication over the network 108. The evaluation report artifact is data representing a displayable or otherwise processable table of respective bidders and project items of the project of the new/open bid, together with average unit prices of each bidder for the project items, the evaluated estimate total for each bidder, and an average overall total for all bidders. The table can include additional information represented by the metadata retrieved by the bid/award unit 114 from the database 106b, such as project item descriptions, units of measure, bid dates, engineer estimates, and other similar information as applicable in the embodiment.

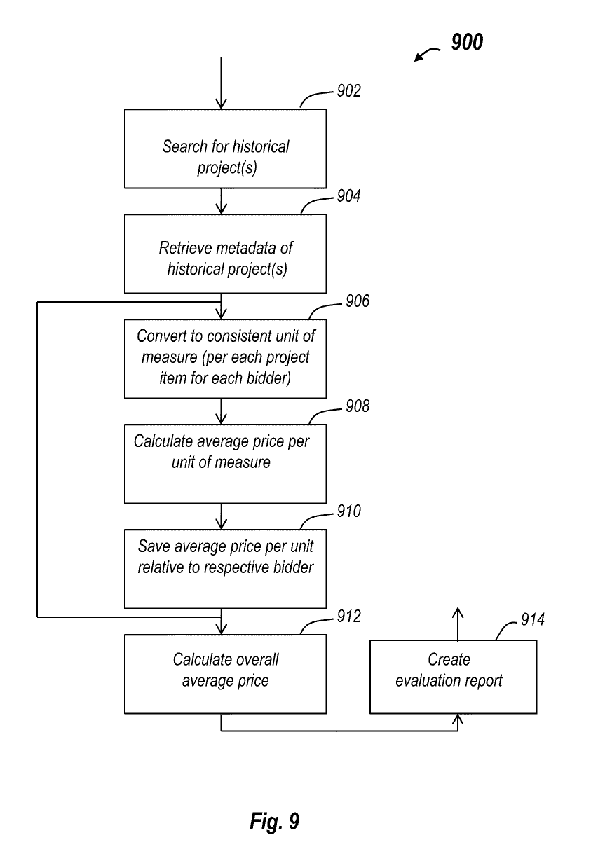

Referring to FIG. 9, a method 900 of evaluating historical bids is performed by the evaluation server 104 in conjunction with the bid/award database 106b. The method 900 is an exemplary embodiment of further details of operations of the bid/award unit 114 and the evaluation report server 116 of the evaluation server 104 in the steps 712, 714, 716 and 718 of the method 700 of FIG. 7 with respect to historical bids. In a step 902 of the method 900, the bid/award unit 114 searches the bid/award database 106b via a search request for the historical bids. The bid/award unit 114 retrieves a result of the search step 902 in a step 904. The result retrieved in the step 904 is metadata of the database 106b representing one or more project of the historical bids (including bidder(s) identifier, project items, units of measure, quantities, engineer estimate and estimate date).

In a step 906, the bid/award unit 114 processes the result from the steps 902 and 904, correlating in storage of the evaluation server 104 each bidder, and respective project, project items and other metadata, and calculates conversions for all units of measure of project items of the metadata for the historical bids for consistency with the units of measure of same project items. The bid/award unit 114 stores the calculation result in storage of the evaluation server 104. In a step 908, the bid/award unit 114 calculates an average price per the consistent unit of measure for each project item of the metadata for the respective historical bids. The bid/award unit 114 stores the calculated averages in storage of the evaluation server 104.

The bid/award unit 114 correlates the respective calculated consistent units of measure and average prices and relates these to respective bidder of the historical bids. Steps 906, 908 and 910 are performed as to each unique project and respective project item of the historical bids for each of the bidder identifiers. In a step 912, the bid/award unit 114 sums each average unit price for each project item multiplied by the respective quantity of the project item of each historical bid, sums the quantity of the project item of each historical bid for each bidder, and divides the sum by the sum of the quantity of the project item, to obtain and save in storage of the evaluation server 104 an average estimated price for each project item for each bidder of the historical bids. Also in the step 912, the bid/award unit 114 sums the total of all average estimated prices for each project item for each bidder, and divides the sum by the total sum of all quantity of the project item for all bidders, to obtain and save in storage of the evaluation server 104 an evaluated estimate total for all bidders for the projects of the historical bids.

In a step 914, the evaluation report server 116 of the evaluation server 104 creates an evaluation report artifact for communication over the network 108. The evaluation report artifact is data representing a displayable or otherwise processable table of respective bidders and project items of the project of the new/open bid, together with average unit prices of each bidder for the project items, the evaluated estimate total for each bidder, and an average overall total for all bidders. The table can include additional information represented by the metadata retrieved by the bid/award unit 114 from the database 106b, such as project item descriptions, units of measure, bid dates, engineer estimates, and other similar information as applicable in the embodiment.

### Example Embodiment

An example embodiment of an evaluation system accessed by one or more disparate evaluation terminals, includes an evaluation server and a database. The evaluation server, for example, is the evaluation server 104 of FIG. 1 and/or the bid evaluation server device 404 of FIG. 4. The database, for example, is the evaluation database 106 of FIG. 1 and/or the database 406 of FIG. 4 with a user account database of metadata representing customers operating evaluation terminals in the embodiment. Each evaluation terminal, for example, is one of the evaluation client terminal 102 of FIG. 1 and/or the client bid evaluation device 402 of FIG. 4. The evaluation server and database are simultaneously accessible over a network, for example, the Internet, by pluralities of the evaluation terminals communicatively connected to the evaluation terminals and the evaluation server.

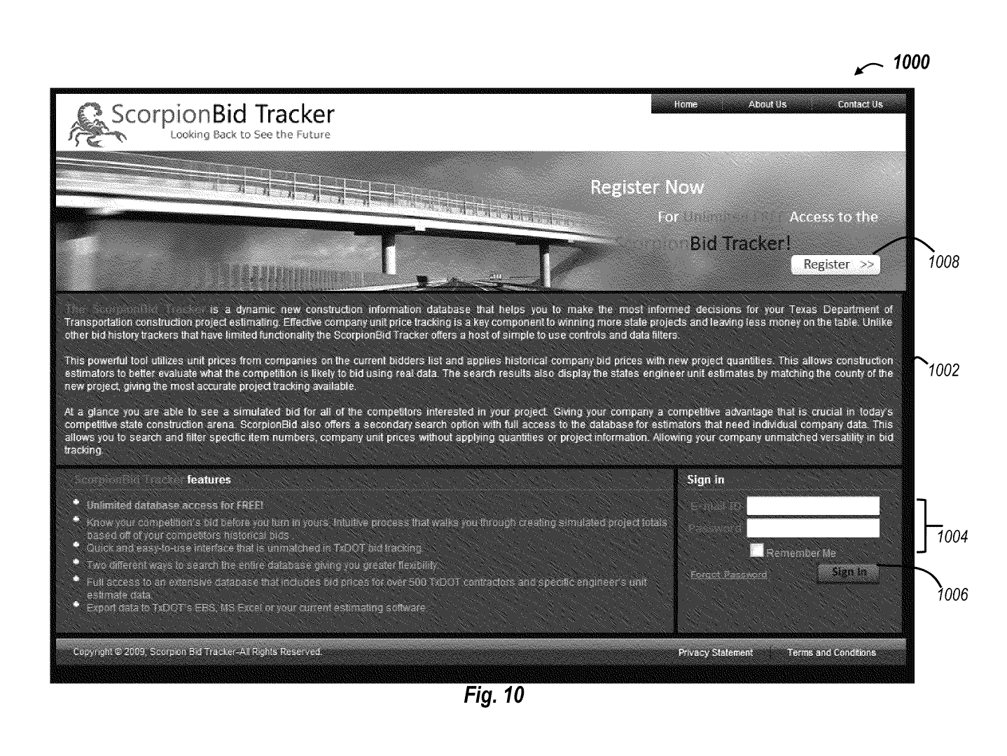

Referring to FIG. 10, the evaluation server communicatively serves, or directs communicative service, to the one or more evaluation terminals over the network of an evaluation website 1000. The evaluation website 1000 is accessed by the evaluation terminals at an address of the network of the evaluation server, such as via a Uniform Resource Locator (URL), an Internet Protocol (IP) address, a Hyperlink such as in a website accessed by the evaluation terminal. An respective evaluation terminal, for example, accesses the evaluation website 1000 using a web browser of the evaluation terminal. The evaluation website 1000 includes multiple pages, as will be described.

An evaluation website access page 1002 of the evaluation website 1000 permits the evaluation terminal to communicate a key, such as a user name and password, or other authorization device, to the evaluation server for authorization by the evaluation server for access to other pages and features of the evaluation website 1000. If the user of the evaluation terminal has the key because previously authorized by the evaluation server for accessing the evaluation website 1000, the key is input by the user to a sign in block 1004 of the website access page 1002 and the user directs the web browser by clicking a sign-in button 1006 to send the key over the network to the evaluation website 1000 for authorization. If the user of the evaluation terminal does not have the key (because not previously authorized by the evaluation server or otherwise authorization is denied by the evaluation server through the user's then-available key), the user of the evaluation terminal directs the web browser by clicking a register button 1008 to request over the network to the evaluation server for registration and the key.

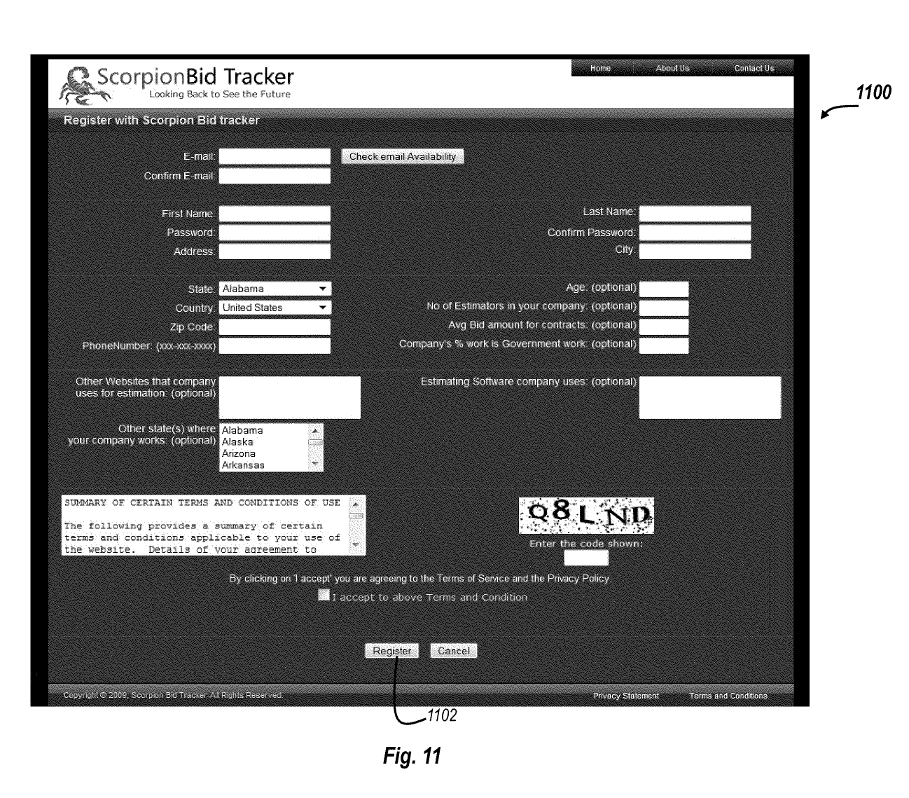

Referring to FIG. 11, on receiving such request from the evaluation terminal, the evaluation server serves, or directs communicative service, to the evaluation terminal over the network of a registration page 1100 of the evaluation website 1000. The registration page 1100 includes sign-in input box permitting the evaluation terminal to communicate identity, and other information representing the user and/or the evaluation terminal, including a desired key, such as name and password. By a click input to a registration button 1102, the web browser of evaluation terminal communicatively submits the identity and other information over the network to the evaluation server for registration by the evaluation server of a new user account in the account database. The evaluation server processes the registration and communicates over the network a confirmation of registration (unless registration is unsuccessful, in which event the registration process must be repeated).

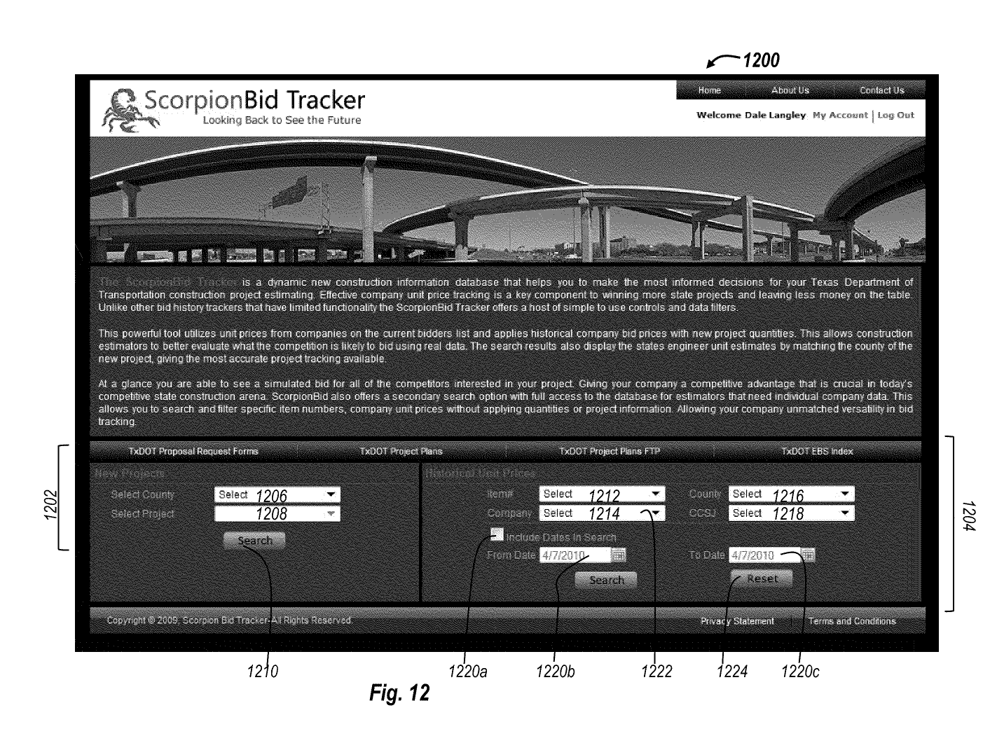

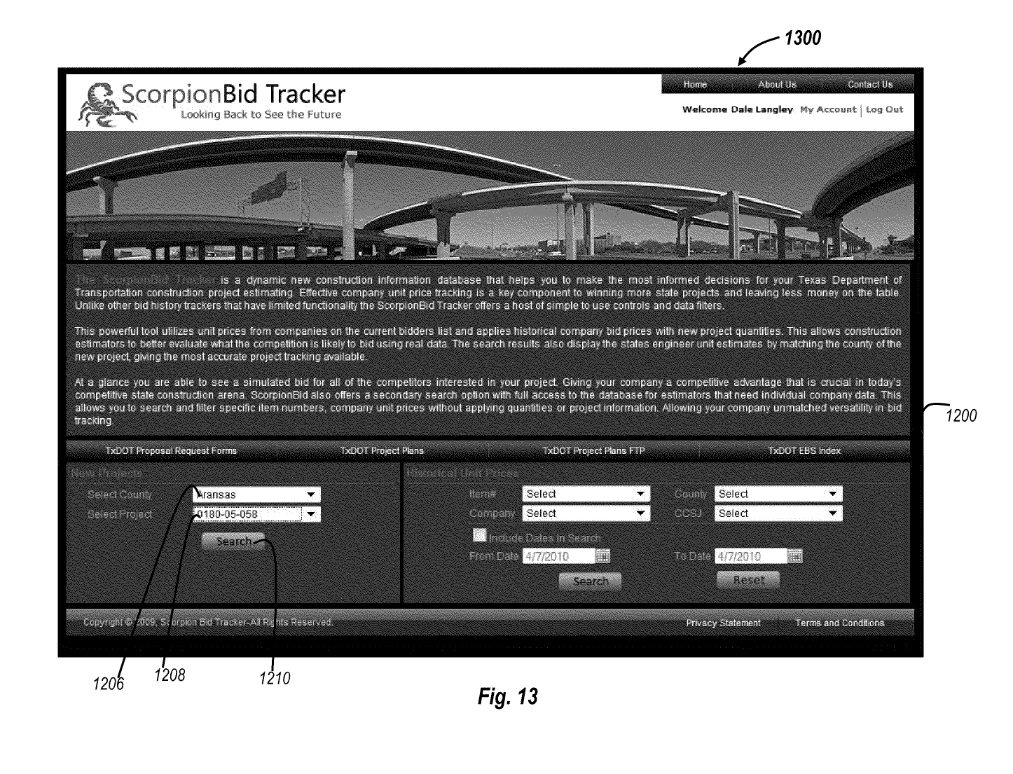

Referring to FIG. 12, once the evaluation terminal has successfully signed-in (including, if applicable, through registration) to access the evaluation server, a projects page 1200 is served, or directed to be served, by the evaluation server to the evaluation terminal. The projects page 1200 includes new/open project input boxes 1202 and historical project input boxes 1204.

The new/open project input boxes 1202 include a county selection box 1206 and a new/open project selection box 1208. The county selection box 1206 permits the evaluation terminal to input a text name identifying a county. On entry by the evaluation terminal of a text name in the county selection box 1206 identifying a county for which new/open project metadata is contained in the database, the new/open project selection box 1208 displays a drop-down menu which lists text identifiers for new/open projects of the county. The evaluation terminal can then select a particular one of the text identifiers for new/open projects of the county, such as by mouse click on the applicable text identifier. The text identifier then appears in the new/open project selection box 1208. The evaluation terminal communicates the contents of the county selection box 1206 and the new/open project selection box 1208 over the network to the evaluation server, for example, by mouse click of the evaluation terminal on a new/open project search button 1210 of the projects page 1200.

The historical project input boxes 1204 include a project item selection box 1212, a company selection box 1214, a county selection box 1216, and a historical project selection box 1218. Additionally, the historical project input boxes 1204 include date selection boxes 1220a-c. Each of the project item selection box 1212, the company selection box 1214, the county selection box 1216, and the historical project selection box 1218 is independently selectable for input by the evaluation terminal, or section of the respective boxes 1212, 1214, 1216, and 1218 can be made by the evaluation terminal in any combination for input. For example, the evaluation terminal can select only the project item selection box 1212 for input. Alternately, for example, the evaluation terminal can select the project item selection box 1212 for input, and also select another of the boxes 1214, 1216, or 1218 for input. Other single one of the boxes 1214, 1216, 1218 and combinations of the boxes 1212, 1214, 1216 and/or 1218 can be selected for input. If at least one of the boxes 1212, 1214, 1216 or 1218 is selected for input by the evaluation terminal, the evaluation terminal can additionally select, if desirable, a date range by check input to the date selection box 1220a and selection or input of respective outer dates of the date range in the date selection boxes 1220b and 1220c. According to certain embodiments, input by the evaluation terminal in any particular box 1212, 1214, 1216 or 1218, such as by mouse click on the box, activates a drop-down menu display in the applicable box of the projects page 1200 or displays a next page for further selection of input by the evaluation terminal. Upon input by the evaluation terminal to selected ones of the boxes 1212, 1214, 1216 and/or 1218, and any input to select date range in the date selection boxes 1220a-c, if desired, the evaluation terminal communicates the contents of the boxes 1212, 1214, 1216 and/or 1218, and 1220a-c, if applicable, over the network to the evaluation server, for example, by mouse click of the evaluation terminal on a historical project search button 1222 of the projects page 1200. The projects page 1200 can also include a reset button 1224, for example, to allow modification of input by the evaluation terminal to boxes 1212, 1214, 1216, 1218 and/or 1220a-c prior to communication to the evaluation server.

Referring to FIG. 13, a new/open project tracker device 1300 includes the projects page 1200 of FIG. 12 illustrating inputs by the evaluation terminal to the county selection box 1206 and the new/open project selection box 1208. The evaluation terminal can choose the search button 1210, such as by mouse click on the button 1210, and the new/open project tracker device 1300 communicates an artifact representing the new/open project tracker device 1300, including the identified county of the county selection box 1206 and the identifier for new/open projects of the county of the new/open project selection box 1208, over the network to the evaluation server. On receiving the artifact by the evaluation server, the evaluation server parses the artifact and writes a search request for controlling retrieval of metadata of the database representing the applicable project of the county corresponding to the identifier for the new/open project. The evaluation server searches the database according to the search request to obtain one or more bidder identifiers of the metadata of the database representing the applicable project.

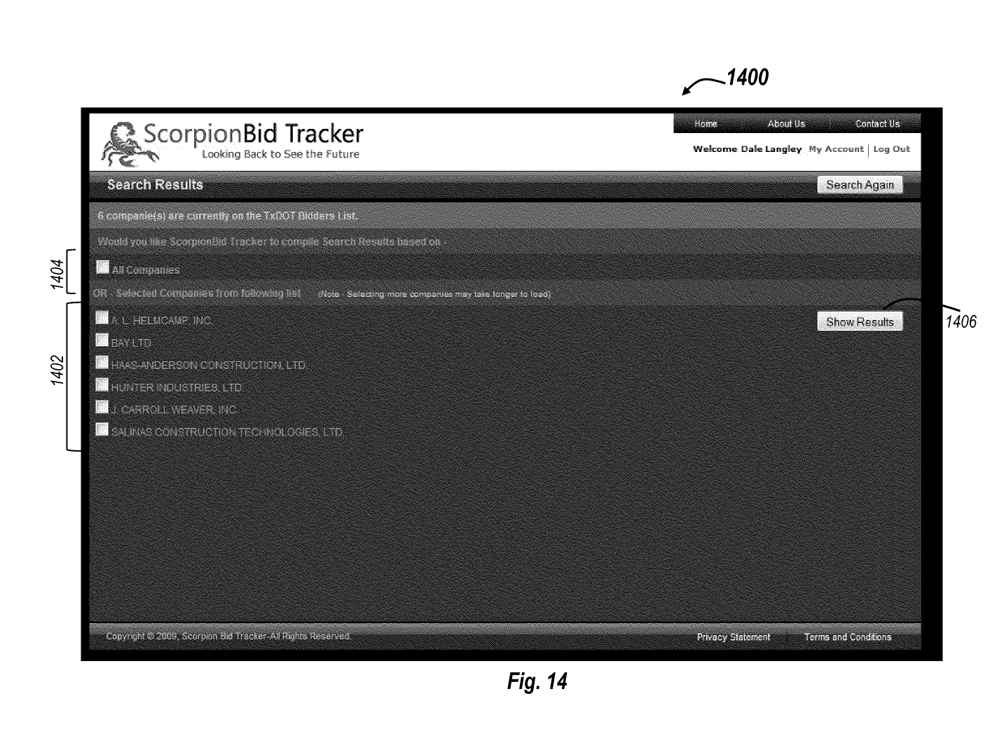

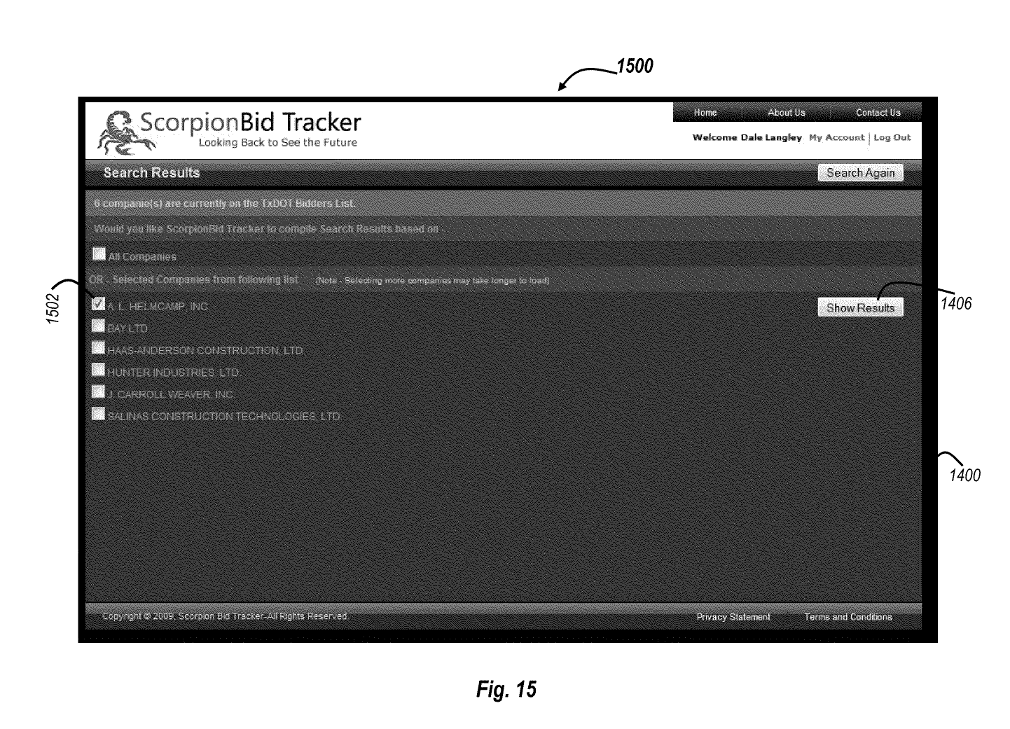

Referring to FIG. 14, if data representing bidder identifiers are obtained in the search of the database, the evaluation server communicates a bidder name page 1400 over the network to the evaluation terminal for display. The bidder name page 1400 contains company names 1402 of bidders of bids then having been received in response to a request for proposal of the new/open project. The bidder name page 1400 also includes respective check boxes 1402 for each bidder and a check box 1404 for selection of all of the respective check boxes 1402. The evaluation terminal can choose among the check boxes 1402 and 1404, such as by mouse click, in the bidder name page 1400. The evaluation terminal sends an artifact representing the selected check boxes 1402 and 1404 over the network to the evaluation server, by choosing a show results button 1406 of the bidder name page 1400 by mouse click or similar input action.

On receiving the artifact representing the selected check boxes 1402 and/or 1404, the evaluation server searches the database to obtain metadata of the database representing the new/open project, such as data representing a request for proposal of the new/open project. The metadata of the new/open project includes data representing the project bidder identifier(s) for the chosen bidders of the bidder name page 1400, and project item identifiers, project item descriptions, units of measure of project items, quantities of project items per the respective unit of measure, engineer estimates of quantity of project items per the respective unit of measure, and engineer price estimate of project items of the new/open project. The evaluation server also searches the database to obtain metadata of the database representing historical project bids of the chosen bidder(s) made by these bidders in response to requests for proposal for historical projects. This metadata includes project item identifiers, units of measure of the project items, quantities of the project items per the respective unit of measure, bid prices of the project items, and dates of the bid prices, each of the historical project bids of the chosen bidder(s).

On retrieving the metadata of the database of the new/open project and the particular historical project bids, the evaluation server calculates conversions as may be required for consistency of units of measure of project items to correspond with units of measure of the request for proposal of the new/open project. The evaluation server also calculates average bid prices of project items of each bidder, calculates estimated bid prices for the project items per the applicable unit of measure based on the average bid prices of each bidder, and calculates an estimated total bid for each bidder. The evaluation server communicates over the network to the evaluation terminal an estimated bid artifact for display or other processing by the evaluation terminal.

FIG. 15 is an exemplary embodiment 1500 of the bidder name page 1400 in which the evaluation terminal has chosen a single bidder check box 1502 of the displayed list of bidders for the new/open project. The evaluation terminal sends an indicator representing the choice of the check box 1502 over the network, to the evaluation server, upon a user's direction to the evaluation terminal, such as by mouse click on the show results button 1406.

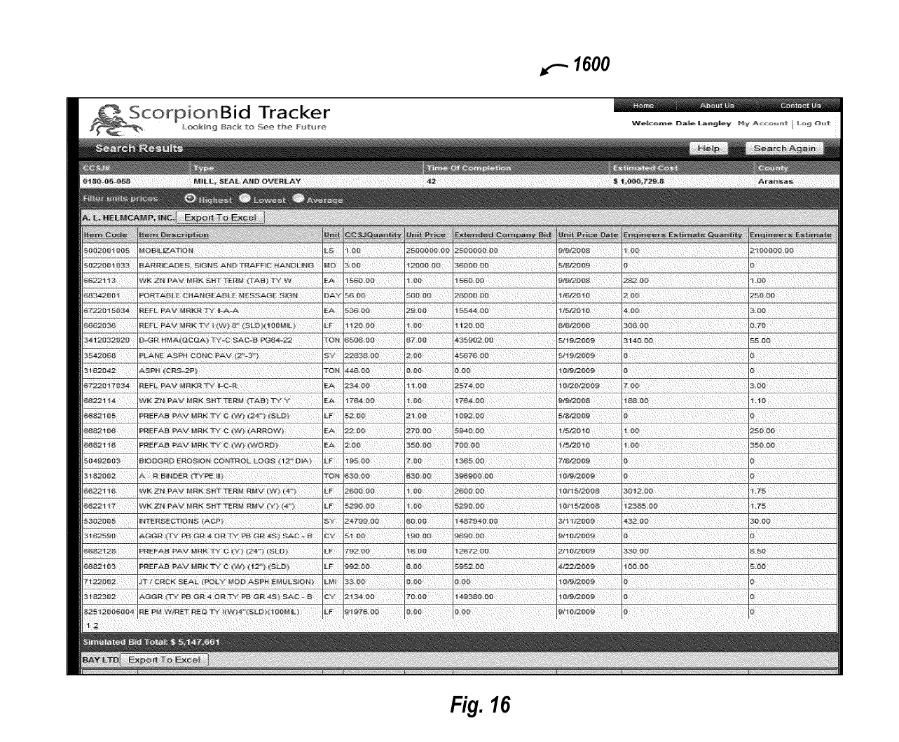

Referring to FIG. 16, if the evaluation terminal receives the indicator for the bidder choice of the evaluation terminal, the evaluation terminal writes a search request in respect to the new/open project and the bidder choice and controls the database to search for metadata of the database representing the new/open project and chosen bidder. Via the search request, the evaluation terminal also controls the database to search for metadata of historical projects of the chosen bidder, in particular metadata representing project items, pricing, units of measure, and other details of historical projects of that bidder which correspond to metadata representing project items of the new/open project. The evaluation terminal retrieves results of the searching, calculates conversions (as may be required) to conform to units of measure for the new/open project, calculates averages of unit prices for project items based on historical bids of the project items of the bidder, calculates estimated bids of the bidder for project items of the new/open project, and calculates a total estimated bid of the bidder for the new/open project. The evaluation server then creates report an artifact for display of an exemplary evaluation report 1600. The artifact is communicated by the evaluation server over the network to the evaluation terminal. The evaluation terminal can display or otherwise process (e.g., print, export, etc.) the evaluation report 1600.

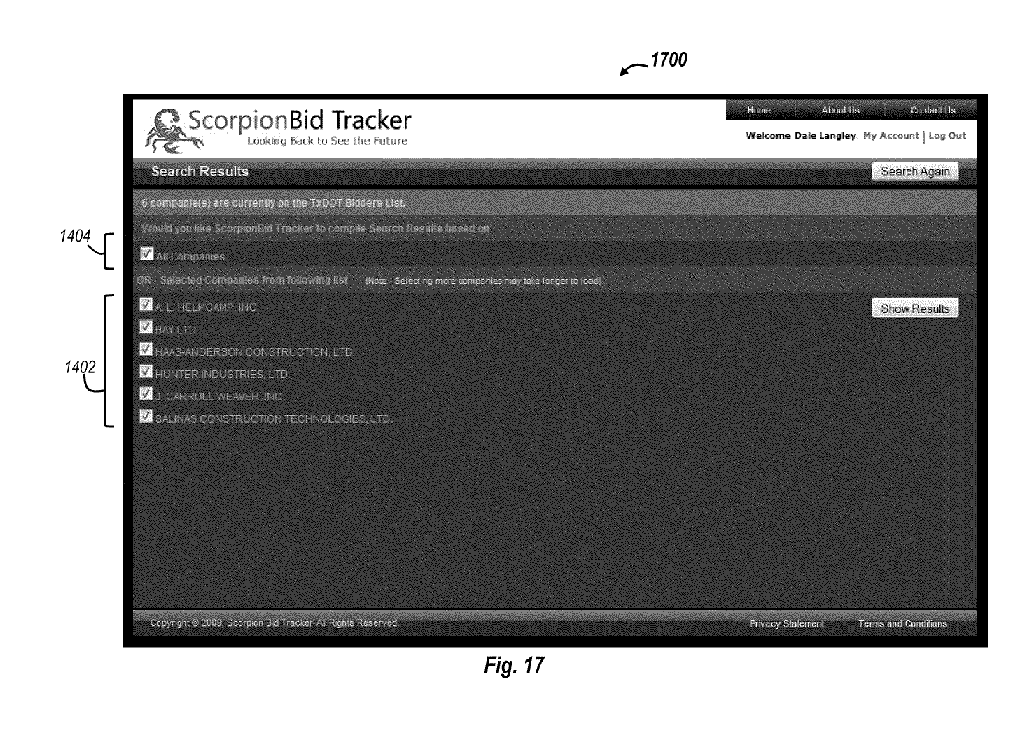

FIG. 17 is an exemplary embodiment 1700 of the bidder name page 1400 in which the evaluation terminal has chosen more than one of the bidder check boxes 1402, in particular, all of the boxes 1402 by check of the all bidders check box 1404.

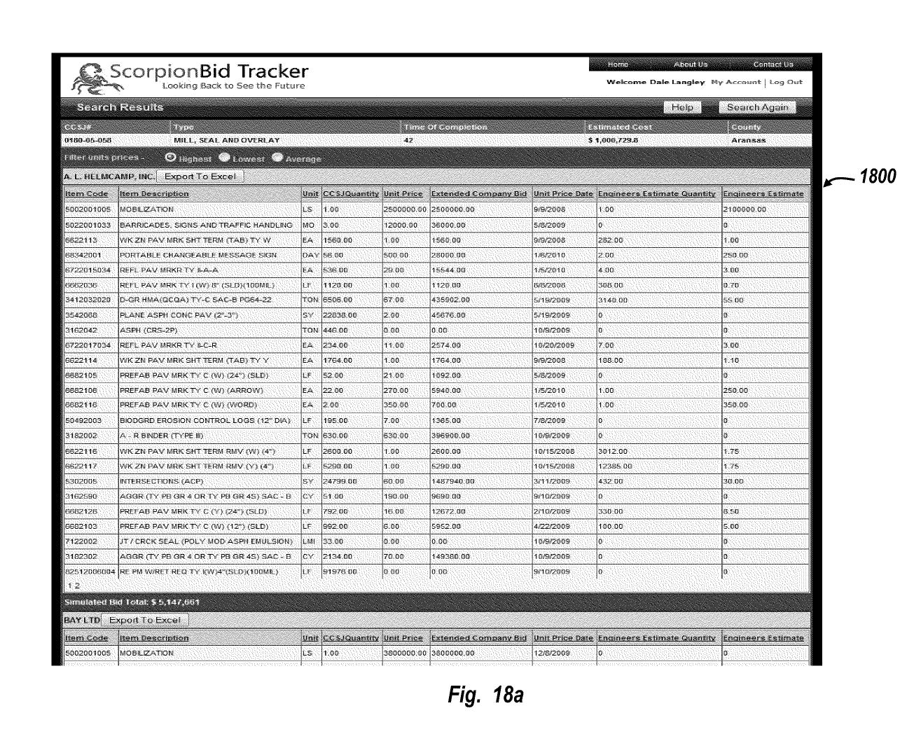

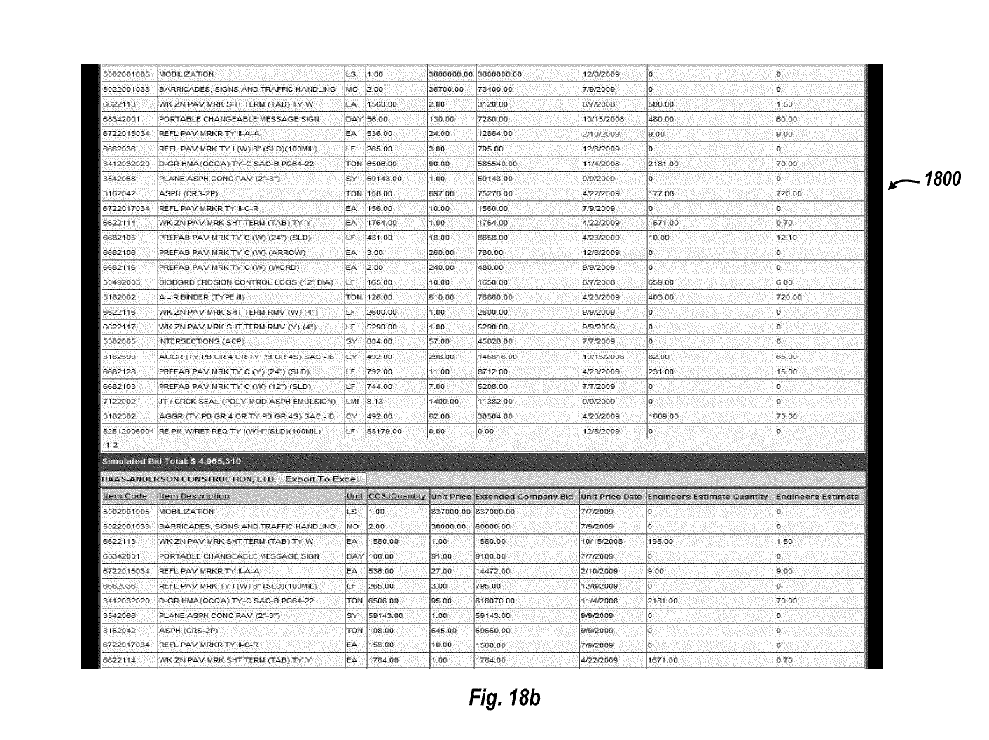

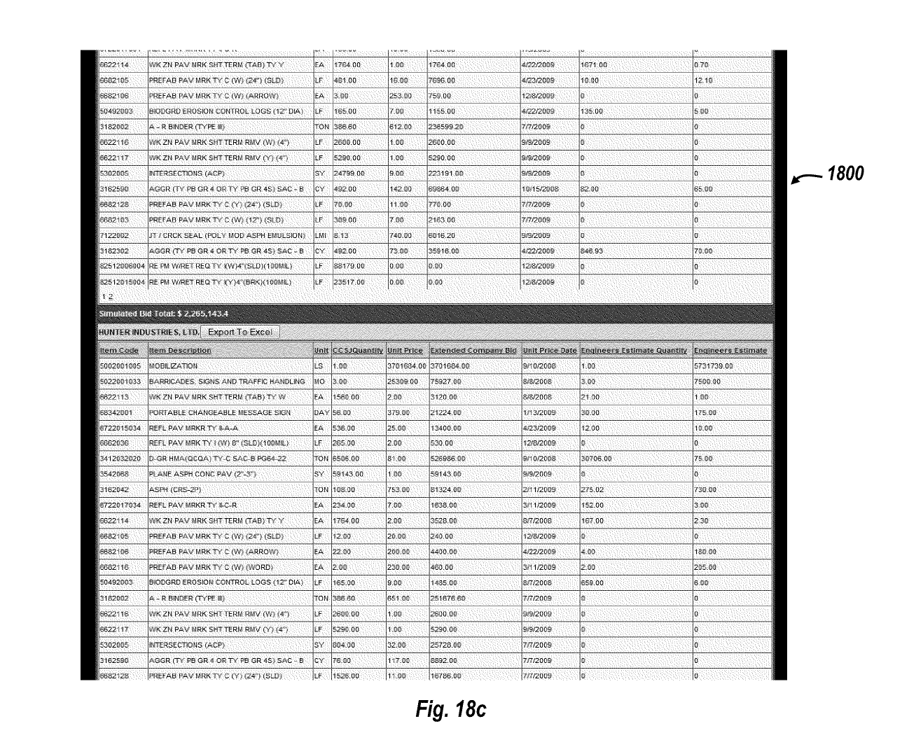

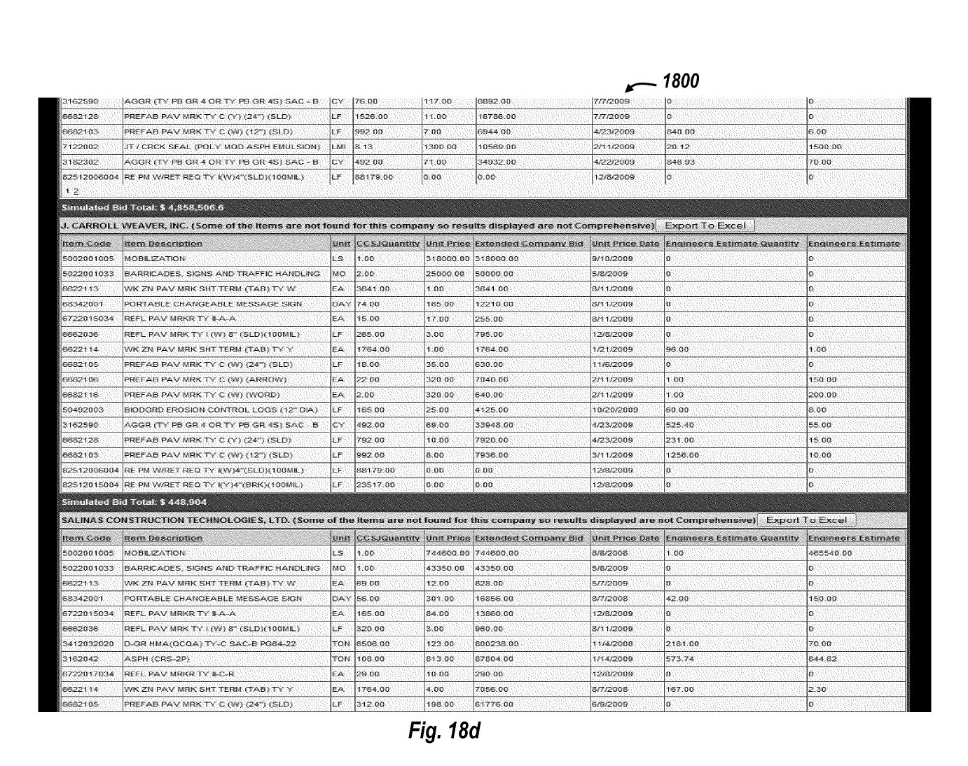

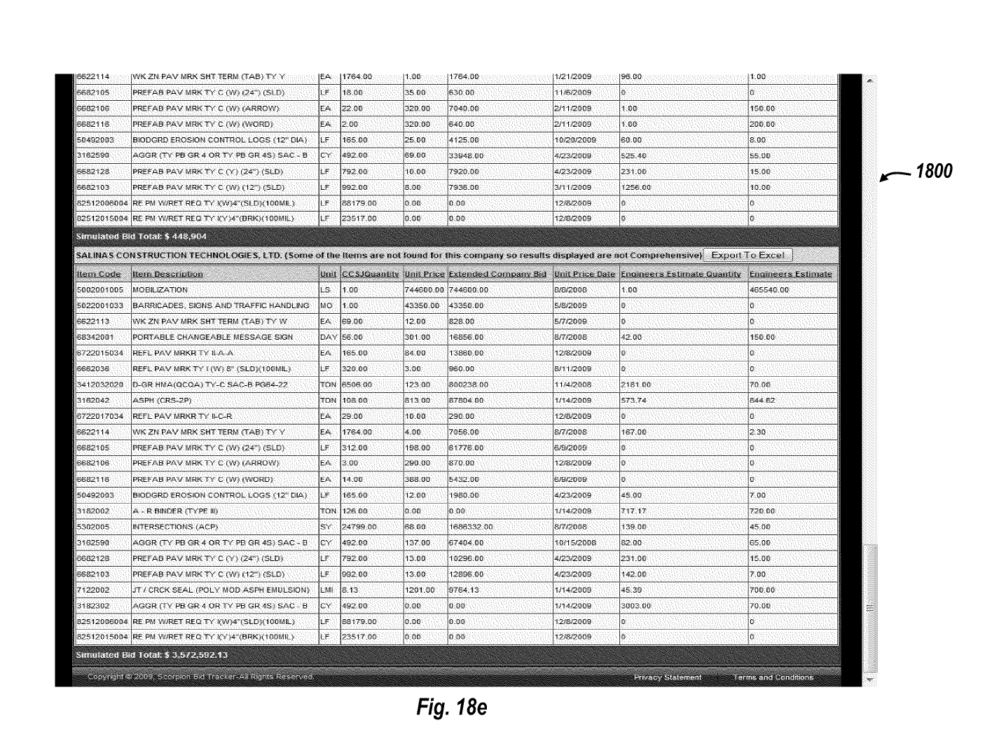

Referring to FIGS. 18a-e, an exemplary resulting evaluation report 1800, for display or other processing by the evaluation terminal, corresponds to the choice of all bidders for the new/open project upon operation of the evaluation server and the database in response to the exemplary embodiment 1700 of FIG. 17 and as has been described.

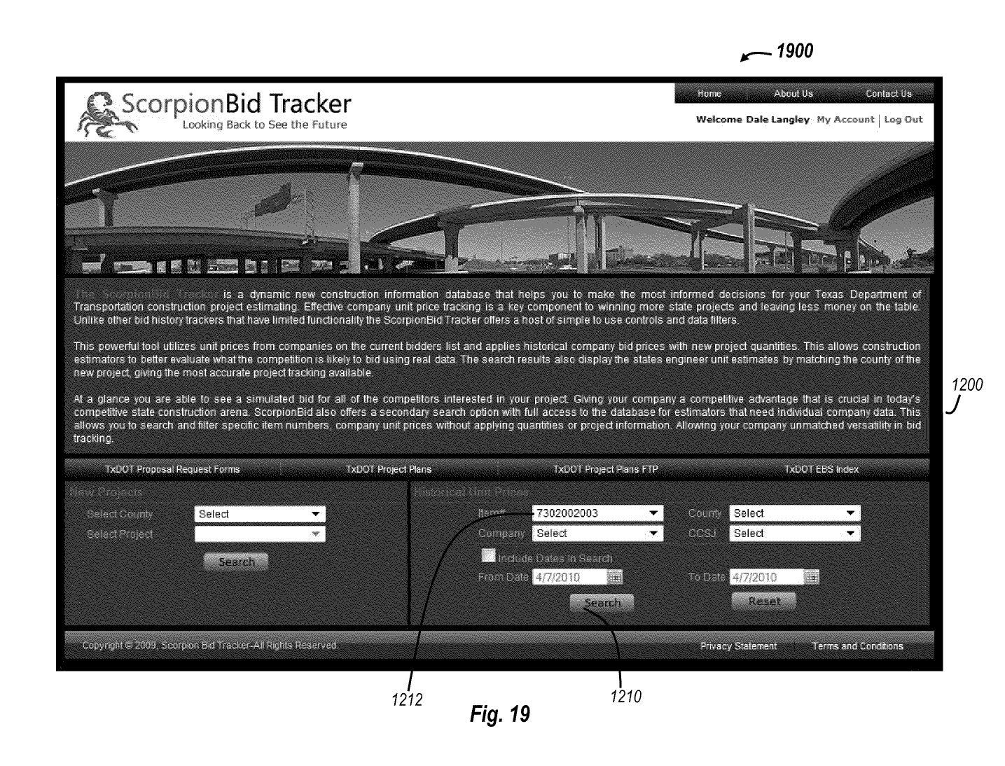

Referring to FIG. 19, a first historical project tracker device 1900 includes the projects page 1200 of FIG. 12 illustrating inputs by the evaluation terminal to the project item selection box 1212. The evaluation terminal can choose the item selection box 1212 to obtain a drop-down menu (not shown) in the projects page 1200 of a listing of project items, such as by identifying indicia recognizable to the industry of the application. Alternately, of course, a textual description or graphical depiction of the project item could be shown for selection. The evaluation terminal can choose any of the listing in the drop-down menu and it then appears in the project item selection box 1212 (e.g., “7302002003”) in the historical project tracker device 1900. The evaluation terminal can then chose the search button 1210, such as by mouse click on the button 1210, and the first historical project tracker device 1900 communicates an artifact representing the tracker device 1900 over the network to the evaluation server.

On receiving the artifact, the evaluation server parses the artifact, and writes a search request for controlling search of the database for metadata representing project items of historical projects corresponding to the project item of the project item selection box 1212. The metadata obtained by the evaluation server from searching includes data representing unit prices, units of measure, bidder identifiers, and other details of historical projects in which bidders made bids in response to requests for proposal for the historical projects. The evaluation server calculates conversions, as may be required, calculates average unit prices for each bidder of the historical projects, and calculates an overall average unit price per the unit of measure for all historical bids of bidders of the historical projects.

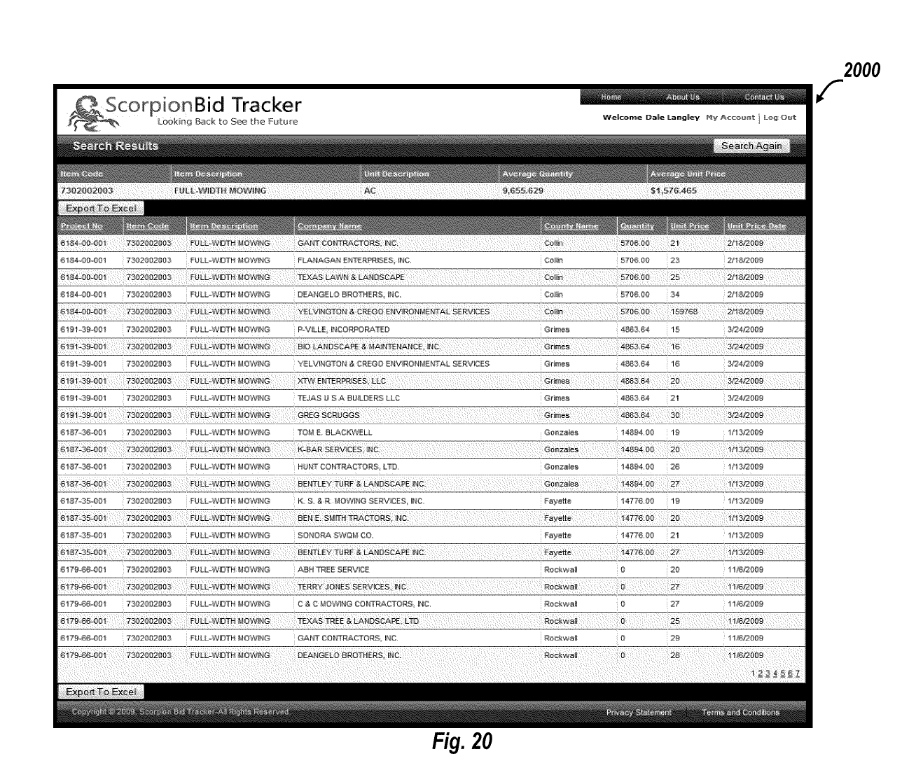

Referring to FIG. 20, an exemplary historical unit price evaluation report 2000, for display or other processing by the evaluation terminal, corresponds to the choice of project item for the historical projects, upon operation of the evaluation server and the database and communications to the evaluation terminal.

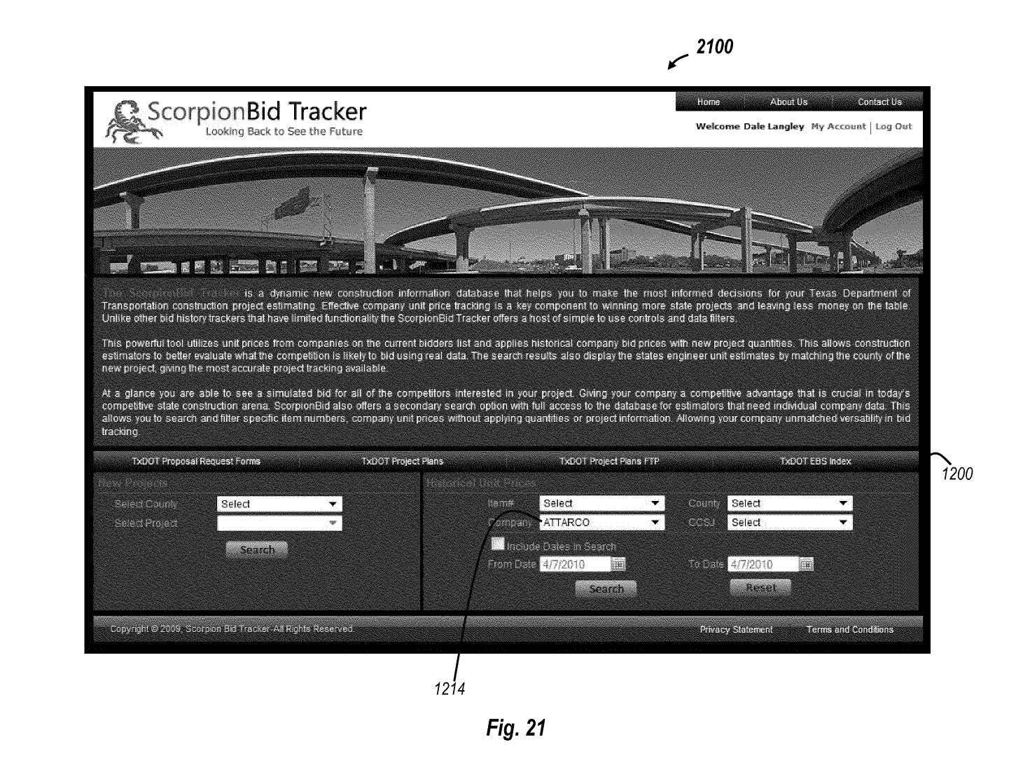

Referring to FIG. 21, a second historical project tracker device 2100 includes the projects page 1200 of FIG. 12 illustrating inputs by the evaluation terminal to the company selection box 1214. The evaluation terminal can choose the company selection box 1214 to obtain a drop-down menu (not shown) in the projects page 1200 of a listing of company names for companies making bids on historical projects. The evaluation terminal can choose any of the listed company names to appear in the company selection box 1214 (e.g., “ATTARCO”) in the historical project tracker device 2100. The evaluation terminal can then chose the search button 1210 to communicate an artifact representing the tracker device 2100 over the network to the evaluation server.

On receiving the artifact, the evaluation server parses the artifact and writes a search request for controlling search of the database for metadata representing historical projects corresponding to the company name of the company selection box 1214. The metadata obtained by the evaluation server from the search includes data representing project items, unit prices, units of measure, quantities of project items, and other details of historical projects for the company name of the company selection box 1214. The evaluation server calculates conversions, as may be required, calculates average quantities of project items of the historical projects, and calculates unit prices of the historical projects corresponding to the company name of the company selection box 1214.

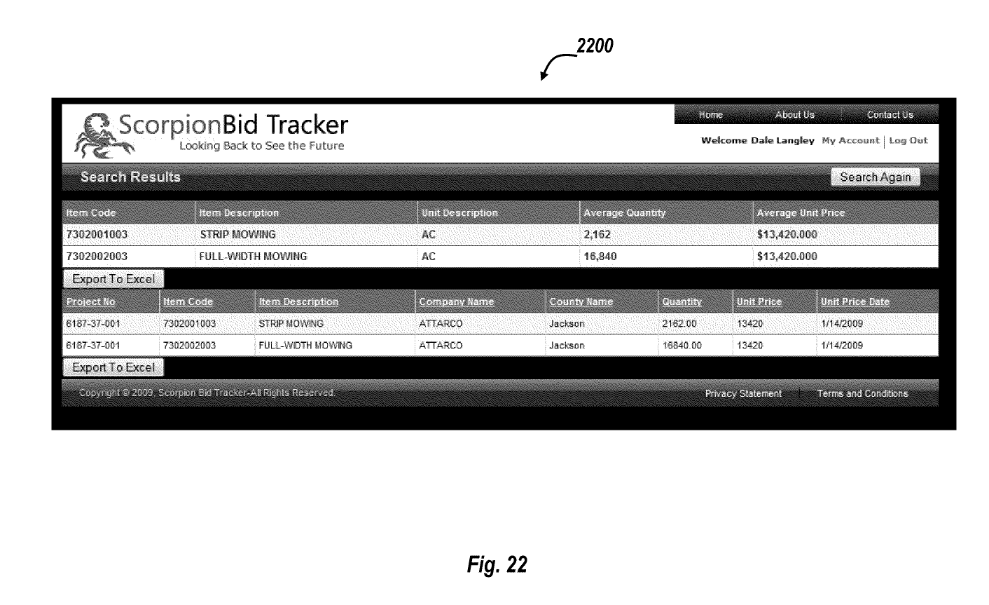

Referring to FIG. 22, an exemplary historical bidder evaluation report 2200, for display or other processing by the evaluation terminal, corresponds to the choice of company for the historical projects, upon operation of the evaluation server and the database and communications to the evaluation terminal.

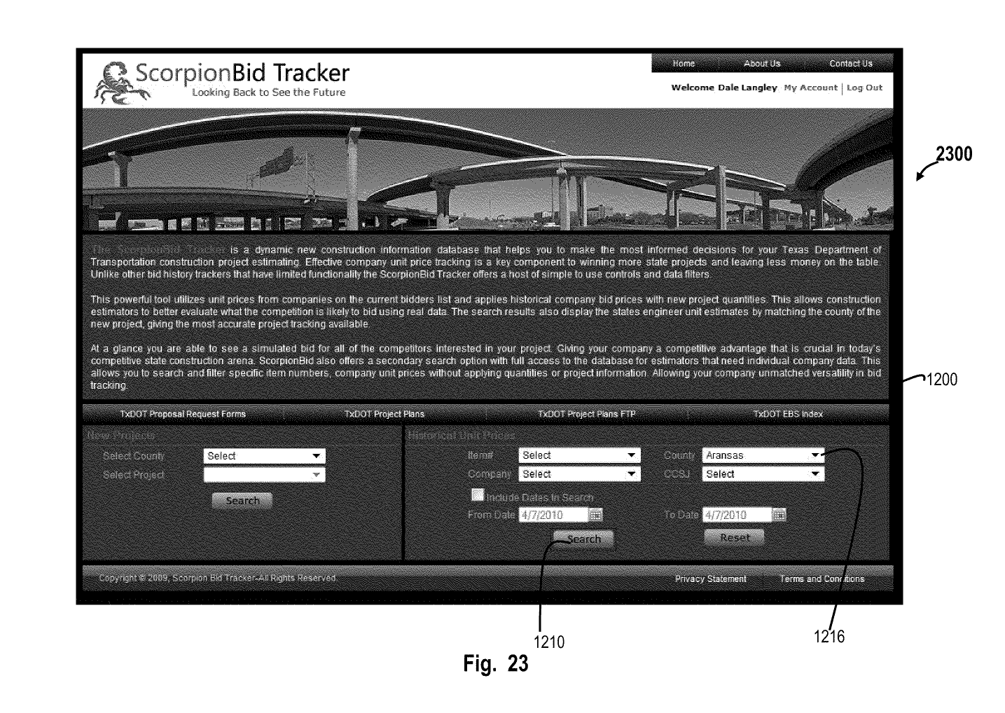

Referring to FIG. 23, a third historical project tracker device 2300 includes the projects page 1200 of FIG. 12 illustrating inputs by the evaluation terminal to the county (i.e., location) selection box 1216. The evaluation terminal can choose the county selection box 1216, obtain a drop-down menu (not shown), and a listing of counties (or locations, as applicable) of historical projects. The evaluation terminal can choose among the list, and the choice appears in the county selection box 1216 (e.g., “Aransas”). The evaluation terminal communicates, such as by choosing the search button 1210, an artifact representing the tracker device 2300 over the network to the evaluation server.

On receiving the artifact, the evaluation server parses the artifact and writes a search request. The search request written by the evaluation server controls search of the database for metadata representing historical projects corresponding to the county (or location) of the county selection box 1216. The evaluation server calculates conversions of units of measure of project items of the historical projects, as may be required, and calculates average unit prices of each project item of all of the historical projects corresponding to the county (location) of the county selection box 1216.

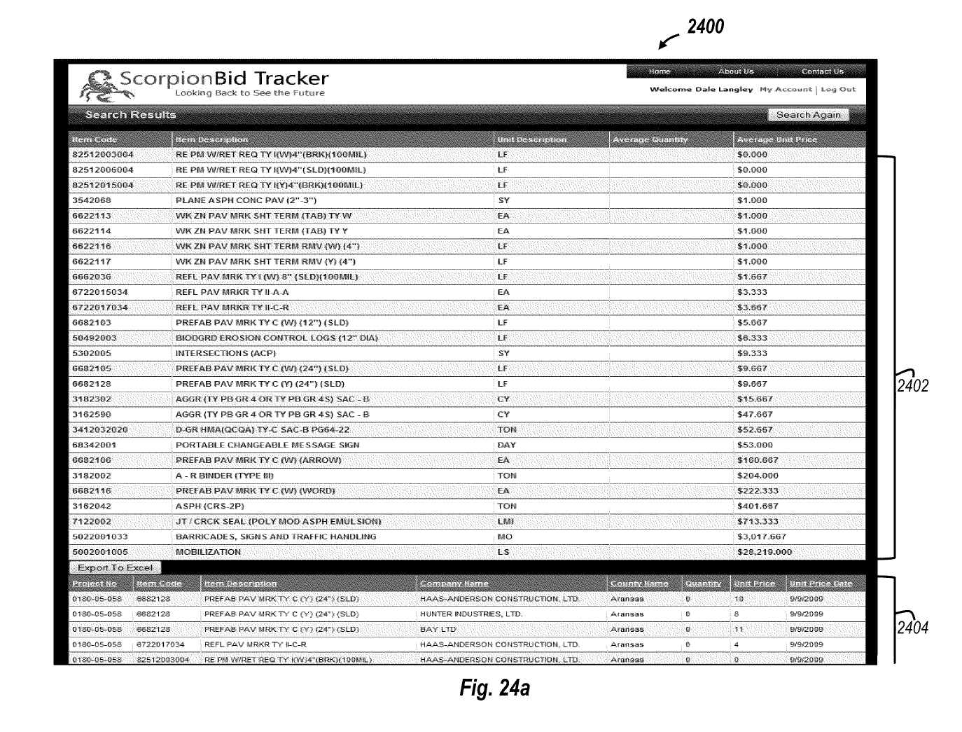

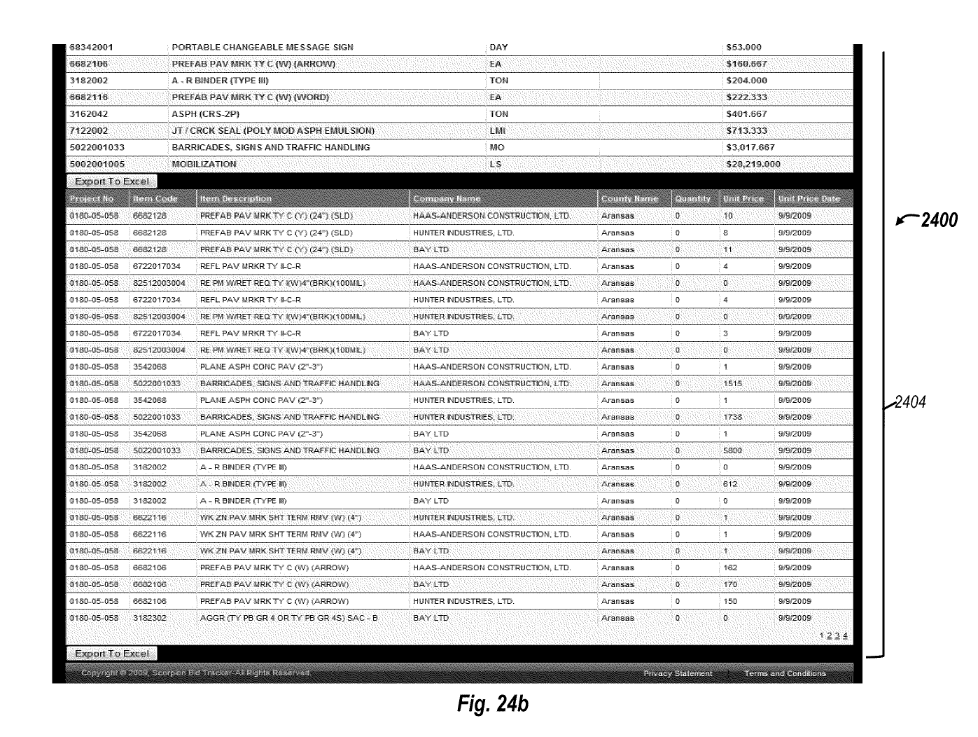

Referring to FIGS. 24a-b, an exemplary location evaluation report 2400, for display or other processing by the evaluation terminal, corresponds to the choice of county (or location, as applicable) for the historical projects. The location evaluation report 2400 contains average unit price 2402 of each project item of the historical projects of the location and also contains particular project items, unit prices, and other details for each respective historical project of the location.

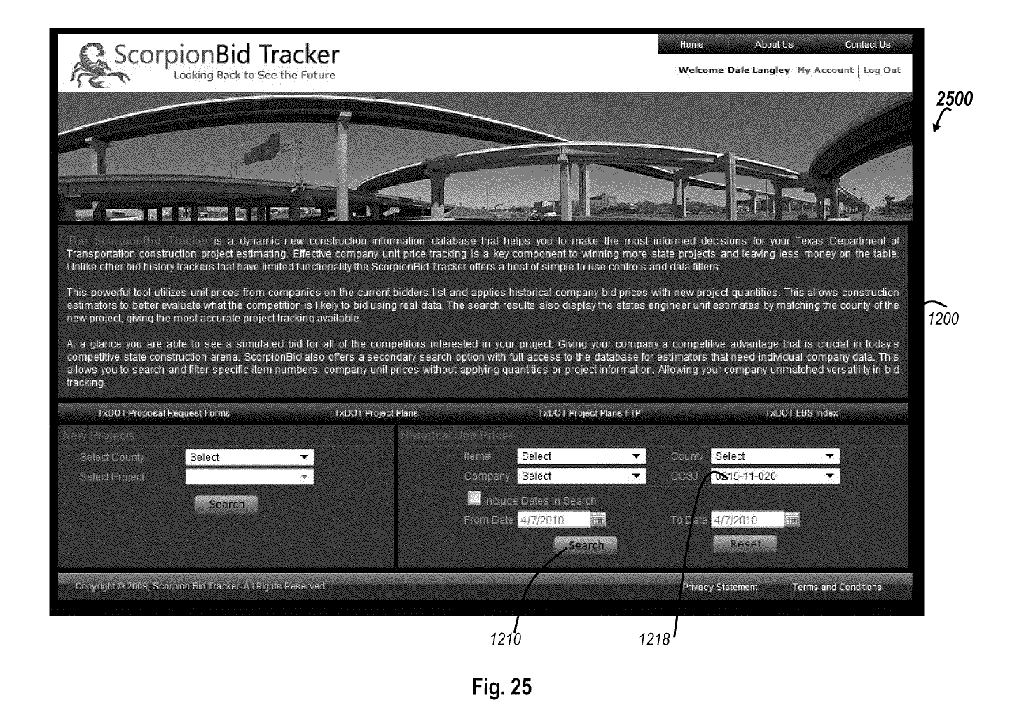

Referring to FIG. 25, a fourth historical project tracker device 2500 includes the projects page 1200 of FIG. 12 illustrating inputs by the evaluation terminal to the historical project selection box 1218. The evaluation terminal chooses a historical project identifier of the historical project selection box 1218 (e.g., “0215-11-020”) from a drop-down menu (not shown). The evaluation terminal chooses the search button 1210 and communicates an artifact representing the tracker device 2500 over the network to the evaluation server.

The evaluation server parses the received artifact and writes a search request. The search request so written controls search of the database for metadata representing the historical project corresponding to the historical project identifier of the historical project selection box 1218. The evaluation server obtains search results, calculates conversions of units of measure of project items of the historical projects as may be required, calculates average unit prices of project items of the historical project for each historical bid and bidder, and calculates overall average unit prices of project items of the historical project based on historical bids of all bidders.

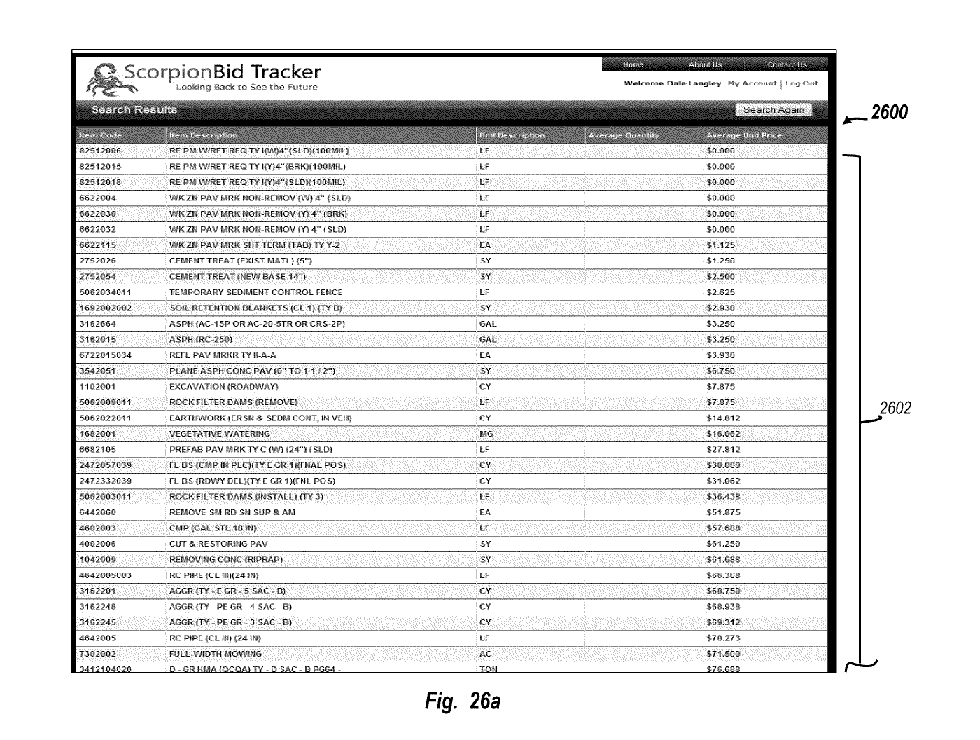

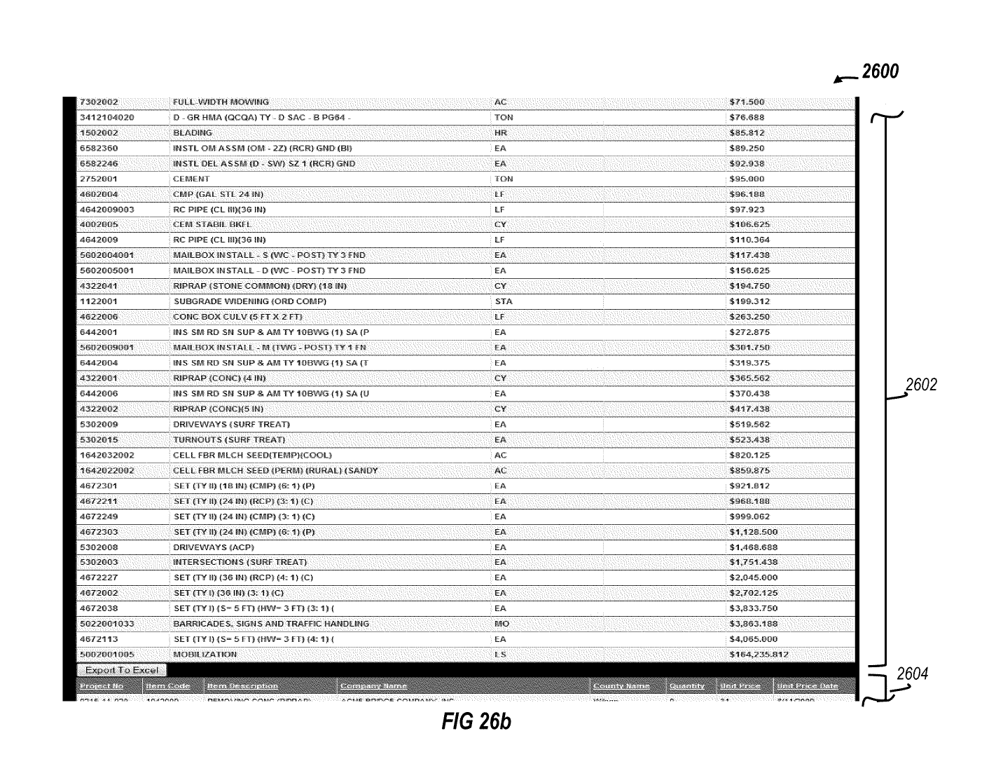

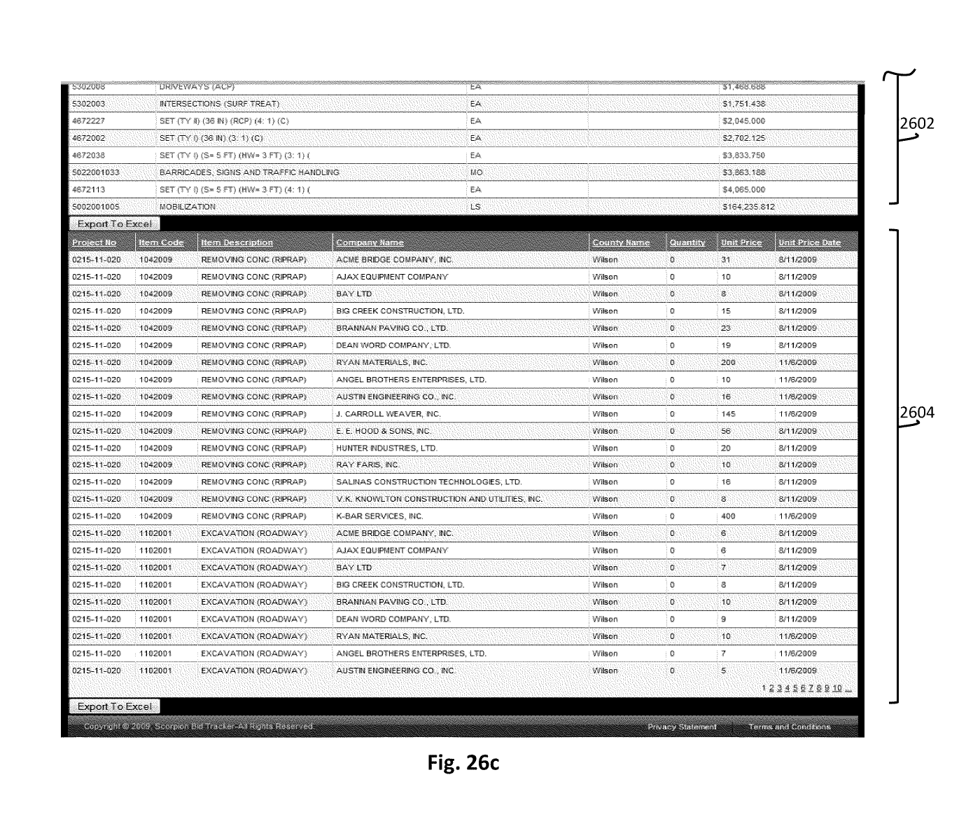

Referring to FIGS. 26a-c, an exemplary project unit price evaluation report 2600, for display or other processing by the evaluation terminal, corresponds to the choice of historical project. The project unit price evaluation report 2600 contains overall average unit prices 2602 of project items of the historical project based on historical bids of all bidders and individual average unit prices 2604 of project items of the historical project for each historical bid and bidder.

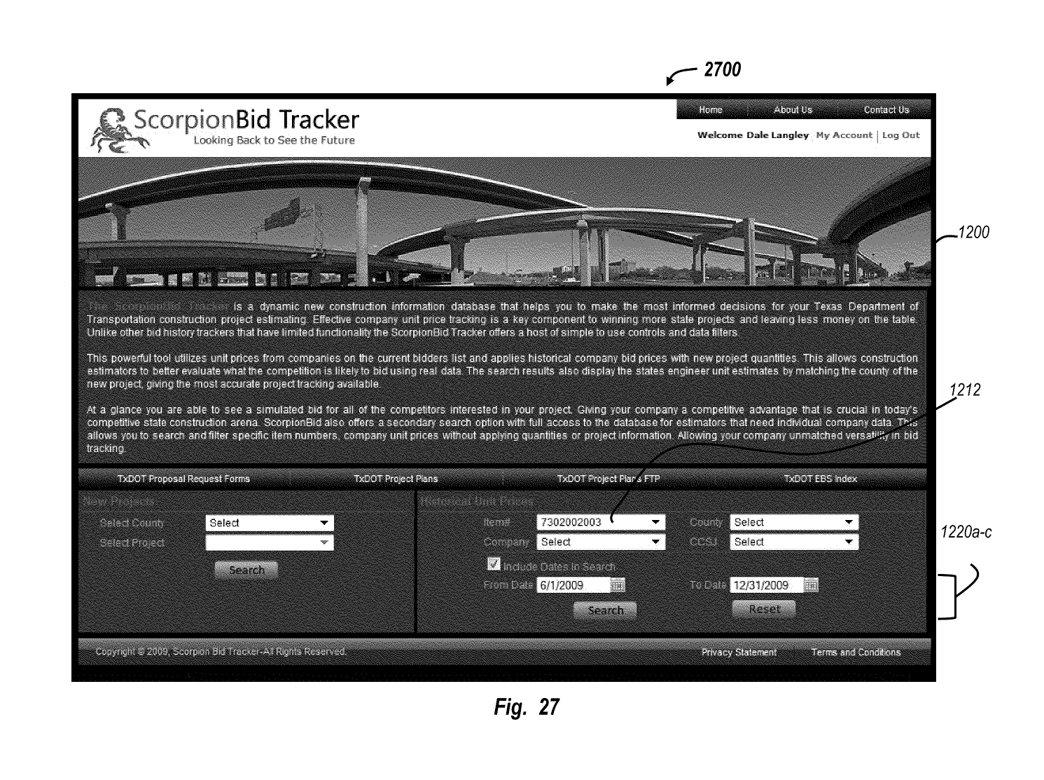

Referring to FIG. 27, a fifth historical project tracker device 2700 includes the projects page 1200 of FIG. 12 illustrating inputs by the evaluation terminal to the project item selection box 1218 and also to the date selection boxes 1220a-c. Same operations as previously described occur, however, the artifact communicated by the evaluation terminal to the evaluation server represents the tracker device 2700 with dual parameters (i.e., project item and date range) for the evaluation server to recognize in writing an applicable search request. The inclusion of date range input by the evaluation device requires the evaluation server to write the search request to constrain searching of the database to historical projects relevant to only the date range. Similar choice to more than one of the boxes 1212, 1214, 1216 and 1218, in combination, requires the evaluation server to write the search request to include only historical projects relevant to the combination.

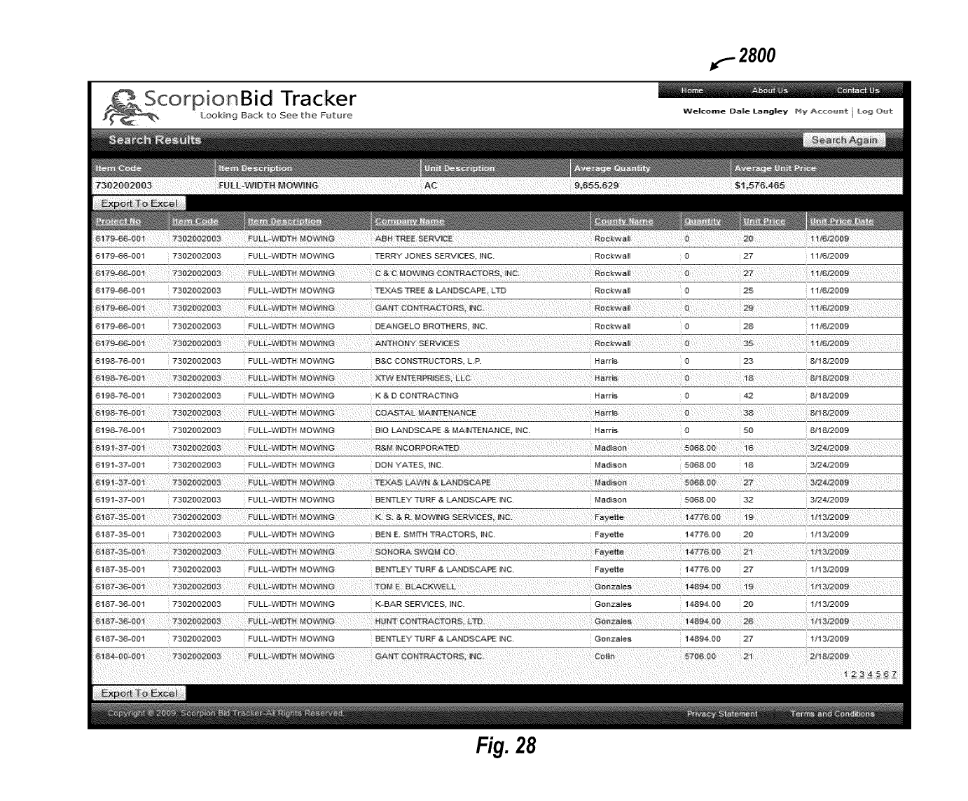

Referring to FIG. 28, after parsing, searching, metadata retrieval, and calculations by the evaluation server related to a received artifact of the tracker device 2700 (or other tracker device, as may be applicable on selection of combined ones of the boxes 1212, 1214, 1216, 1218 and/or 1220a-c), an exemplary evaluation report 2700, for display or other processing by the evaluation terminal, corresponds to the relevant metadata of the historical project for the particular tracker device 2700. For example, the exemplary evaluation report 2700 contains averaged unit prices for consistent units of measure, bidders, location, and other details of historical projects.

A wide variety of alternatives, substitutions, modifications, and variations are possible in the embodiments. In certain alternatives, for example, an evaluation service provides a website accessible to communicatively connected computers for obtaining evaluation reports for project bids. The evaluation service charges users of devices for access to the website to obtain evaluation reports. The evaluation service can additionally provide access to additional features, files, information, analytical tools, evaluation assessment operations, and other resources available by the website access, and the evaluation service may assess additional charge to users for the access. An example of such an additional feature can include an administrator category or level which evaluates statistics for projects, project items, and other specifics, such as regional or locational project “hot spots” based on fluctuating price changes; arbitrage characteristics and affects of projects, markets, and the like; trend patterns and set statistics for regions, companies, markets and other indicators, and pointed statistical presentation for specific company, city, project item detail, and others.

In other alternatives, the evaluation server is maintained by a company, group, or enterprise, and access to the evaluation server to obtain evaluation reports is restricted to certain users or devices, such as employees or agents of the company, group, or enterprise. Other alternatives include automated retrieval and population of evaluation databases by the evaluation server or operatively connected elements, manual or other population of databases. Databases and contents can be tailored as desired for particular application, industry, bidding scenarios, and the like, and management and modification of record data, categories, and relationships. Moreover, alerts, notices, and additional interactivity may be implemented in or in conjunction with the evaluation server operations, for example, communications forums for authorized or participating users or devices obtaining evaluation reports of the systems and methods.

In other alternatives, features of the evaluation server, accessing devices, and database can be implemented in alternate configurations, for example, features of the evaluation server can be implemented in the databases, features of the databases in the evaluation server, and features of the client devices, the evaluation servers and/or the databases can be implemented in the others of these devices or in various combinations in the devices. In certain alternatives, a single device can contain all features for project evaluation; such features can be implemented in hardware circuits, software programs contained in computer readable media, and combinations. Other alternatives can include cellular telephone application programs stored and processed by a data-enabled cellular telephone operating as a client device, for example, a cell phone app of the cell phone.

In other and further alternatives, bidding scenarios may require or make desirable different or additional features, different processing, calculations, and data transformations, and/or other changes to specific components, devices, and operations. For example, relationships among database elements can be implemented via computerized calculations of closest match (e.g., matching a nearest county or location to the evaluated location through price estimates and GPS coordinates for location to which estimates apply, etc.) by the server or other devices and processes.

Although the invention has been described in the foregoing with reference to specific embodiments, one of ordinary skill in the art will understand and appreciate that various modifications, alternatives, changes, and variations can be made in the embodiments without departing from the scope of the present invention as set forth in the claims below. Accordingly, the specification and figures are to be regarded in an illustrative rather than a restrictive sense. Additionally, certain benefits, advantages, and solutions to problems have been described above with regard to specific embodiments; nevertheless, the benefits, advantages, solutions to problems, as well as the particular device(s), connection(s) and element(s) that may cause or provide any benefit, advantage, or solution to occur or become more pronounced, are not to be construed as a critical, required, or essential feature or element of any or all the claims. As used herein, the terms “comprises, “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A system for bid evaluation of a project, the project includes project items, one or more prior bid of the project may be pending, one or more historical bid of one or more historical project was previously pending, the one or more historical project includes at least some of the project items, the system is accessible over a data communications network by an evaluation terminal, the system comprising:
a first table containing data representing the project and the one or more prior bid, if any;
a second table containing data representing the one or more historical project and the one or more historical bid of the historical project;
a first index relating data of the first table of the project to data of the first table of the one or more prior bid of the project;
a second index relating data of the second table of each historical project to data of the second table of one of the historical project of the one or more historical project;
a controller communicatively connected to the data communications network and the first table, the second table, the first index and the second index;
a memory connected to the controller;
a script unit connected to the data communications network and the controller, the script unit responsive to communications of the evaluation terminal on the data communications network, the script unit processes received communications of the evaluation terminal;
a search instruction written by the script unit on processing received communications of the evaluation terminal over the data communications network and stored in the memory;
a project bid unit connected to the controller and responsive to the script unit, the project bid unit processes the search instruction to search the first table per the first index and retrieve to the memory the data of the first table representing the project, together with the project items of the project, and the one or more prior bid, if any, of the project, and to search the second table per the second index and retrieve to the memory the data of the second table representing at least certain of the one or more historical bid, together with the project items, respectively, of the historical bid;
an estimated bid of the project and of each of the project items of the project stored in the memory, the project bid unit processes the data of the second table representing the at least certain of the one or more historical bid to obtain the estimated bid for each of the project items of the project;
an evaluation reporter connected to the controller and responsive to the project bid unit; and
an evaluation report, the evaluation reporter processes and stores in the memory each of the project items of the project and the estimated bid of the project item, respectively, associated to the project item, tabularizes the evaluation report presenting the project items of the project and the estimated bid of each project item of the project, and communicates the evaluation report over the data communications network destined to the evaluation terminal.

2. The system of claim 1, further comprising:
a conversion unit connected to the controller and the project bid unit, the conversion unit processes the data of the at least certain of the one or more historical bid and the data representing the one or more prior bids, to comport to the data representing the project items of the project.

3. The system of claim 1, wherein the search instruction relates to one or more historical project but not the project, further comprising:
a historical bid unit connected to the controller and responsive to the project bid unit, the project bid unit processes the search instruction to search the second table per the second index and retrieve to the memory the data of the second table representing the one or more historical bid, together with the project items, respectively, of the historical project of each one or more historical bid; and
an evaluated bid of each of the one or more historical project and the project items, respectively, of each historical project;
wherein the project bid unit processes the data of the second table representing the one or more historical bid to obtain the evaluated bid for each project item of each of the one or more the historical project, averaged for each project item of the one or more historical project;
wherein the evaluation reporter constructs the evaluation report tabularly presenting each project item of the one or more historical project corresponding to the evaluated bid of the project item.

4. The system of claim 1, further comprising:
a computer readable database includes the first table, the second table, the first index, and the second index; and
a server device communicatively connected to the data communications network and to the computer readable database, the server device includes the controller, the memory, the script unit, the search instruction, the project bid unit, the estimated bid, the evaluation reporter, and the evaluation report.

5. A method of evaluating bidding of a project, comprising the steps of:
providing a server device communicatively connected to a data communications network, the server device includes memory and a bid unit and an evaluation report server connected to the memory;
providing a relational database connected to the server device containing data representing the project, data representing any prior bids of the project, and data representing historical bids of historical projects, the project and the historical projects each include respective project items;
receiving by the server device a tracker device identifying the project to the server device, from an authorized client device over the data communications network;
processing the tracker device by the bid unit of the server device to obtain a project identification of the project;
writing a search request stored in the memory by the bid unit for the project identification;
searching the database by the bid unit per the search request, for the data representing the project, the data representing any prior bids of the project, and the data representing historical bids of historical projects related to the project;
retrieving by the bid unit to the memory the data representing the project, the data representing any prior bids of the project, and any of the data representing historical bids of historical projects related to the project;
sorting by the bid unit in the memory the data representing historical bids from the step of retrieving, for each project item related to the project of the historical projects;
calculating by the bid unit an average evaluated bid of each project item of the project based on the historical bids of the project item of the historical projects;
saving in the memory by the bid unit the average evaluated bid of each project item;
relating in the memory by the bid unit the average evaluated bid of each project item to the respective project item of the project;
calculating by the bid unit a cumulative evaluated bid of the project as a sum of the average evaluated bid of each project item of the project;
creating an evaluation report table of the project items of the project by the evaluation report server, the average evaluated bid of each project item, and the cumulative evaluated bid of the project; and
sending the evaluation report table by the server device, over the data communications network to the authorized client device.

6. The method of claim 5, further comprising the steps of:
providing a website of the server device accessible by the authorized client device via the data communications network;
providing a client device account database connected to the server device, the client device account database contains a user account for the authorized client device;
searching the client device account database for the user account after the step of receiving the tracker device and before the step of processing the tracker device;
analyzing the user account by the server device to confirm the authorized client device is permitted to continue the step of processing the tracker device;
delivering by the server device a registration page of the website over the data communications network to the authorized client device, if the step of analyzing fails to confirm the authorized client device is permitted;
wherein the tracker device includes a log-in key of the authorized client device recognizable to the server device.

7. A method of evaluating bidding of a project, comprising the steps of:
receiving by the server device a historical tracker device identifying one or more historical item represented by the data of historical projects of the relational database, from an authorized client device over the data communications network;
processing the historical tracker device by the bid unit of the server device to obtain an item identification of each of the one or more historical item, the item identification is related to one or more project items of the one or more historical projects;
writing a historical search request stored in the memory by the bid unit for the item identification;
searching the database by the bid unit per the historical search request, for any data representing the one or more project items of the one or more historical projects;
saving by the bid unit to the memory the data representing the one or more project items;
sorting by the bid unit in the memory the data representing the one or more project items, to associate the respective data representing each project item, respectively, of the historical bids;
calculating by the bid unit an average historical bid of each project item of the step of saving, based on the historical bids of the project item of the historical projects of the step of sorting by the bid unit in the memory the data representing one or more project items;
storing in the memory by the bid unit the average historical bid of each project item;
relating in the memory by the bid unit the average historical bid of each project item to the respective project item of the historical projects;
creating an historical evaluation report table of the project items and the average historical bid of each project item of the historical projects; and
sending the historical evaluation report table by the server device, over the data communications network to the authorized client device.

8. The method of claim 5, further comprising the steps of:
receiving by the server device a tracker device identifying one or more historical item represented by the data of historical projects of the relational database, from an authorized client device over the data communications network;
processing the tracker device by the bid unit of the server device to obtain an item identification of each of the one or more historical item, the item identification is related to one or more project items of the one or more historical projects;
writing a historical search request stored in the memory by the bid unit for the item identification;
searching the database by the bid unit per the historical search request, for any data representing the one or more project items of the one or more historical projects;
retrieving by the bid unit to the memory the data representing the one or more project items;
sorting by the bid unit in the memory the data representing the one or more project items, to associate the respective data representing each project item, respectively, of the historical bids;
calculating by the bid unit an average historical bid of each project item of the step of retrieving, based on the historical bids of the project item of the historical projects of the step of sorting;
saving in the memory by the bid unit the average historical bid of each project item;
relating in the memory by the bid unit the average historical bid of each project item to the respective project item of the historical projects;
creating an historical evaluation report table of the project items and the average historical bid of each project item of the historical projects; and
sending the historical evaluation report table by the server device, over the data communications network to the authorized client device.

9. A program stored in a computer readable non-transitory medium for processing by a computer, comprising:
a projects metadata storage unit containing data representing a new project, project items of the new project, and any prior bid of the new project and data representing one or more historical projects, project items of each historical project, and bids of each historical project;
a data retrieval unit to retrieve, upon receipt of a project metadata request from an evaluation terminal over a network identifying the new project to the data retrieval unit and a retrieval authorization key, upon confirmation by the data retrieval unit that the retrieval authorization key is acceptable to the data retrieval unit, the data representing the new project, the project items of the new project, and each prior bid of the new project, if any, and a subset of the data representing one or more historical projects, projects items of the historical project, and bids of each historical project corresponding to the project items of the new project;
an evaluation unit to sort the subset according to respective project item of the new project and corresponding project item of the historical projects, and each corresponding bid of the project item of the respective historical projects, and to calculate an estimated bid of each project item as an average of the corresponding bids of the project items of the historical projects, and associate the estimated bid of each project item to the respective project item of the new project;
an evaluation report unit to construct a tabularized presentation of each project item of the project and corresponding estimated bid of the project item.
